(19) United States
(12) Patent Application Publication
(10) Pub. No.: US 2006/0262317 A1
(43) Pub. Date: Nov. 23, 2006

(54) Methods and devices for molecular structure determination

(75) Inventors: Bruce Doak, Tempe, AZ (US); John Spence, Tempe, AZ (US); Uwe Weierstall, Phoenix, AZ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: The Arizona Board of Regents acting on behalf of Arizona State University

(21) Appl. No.: 11/358,237

(22) Filed: Feb. 21, 2006

Related U.S. Application Data
(60) Provisional application No. 60/662,273, filed on Mar. 15, 2005.
(60) Provisional application No. 60/662,467, filed on Mar. 15, 2005.

(51) Int. Cl. G01J 3/45

(52) U.S. Cl. 356/451

(57) ABSTRACT

The present invention provides methods for molecular structure determination using serial diffraction, and devices for carrying out the methods of the invention.

### CROSS REFERENCE

This application claims the benefit of U.S. provisional patent application Ser. Nos. 60/662,273 filed Mar. 15, 2005 and 60/662,467 also filed Mar. 15, 2005, both references incorporated by reference herein in their entirety.

### STATEMENT OF GOVERNMENT INTEREST

This work was supported in part by National Science Foundation, Division of Biological Infrastructure, Program for Instrument and Instrument Development grant number 0429814, Aug. 1, 2004 through Jul. 31, 2006, thus the U.S. government may have certain rights in the invention.

### FIELD OF THE INVENTION

This invention related generally to methods and apparatus for molecular structure determination.

### BACKGROUND OF THE INVENTION

All living organisms consist mainly of protein molecules. Drug molecules (usually much smaller than proteins) act by interacting with proteins (e.g. membrane proteins), and the understanding of this interaction at the atomic scale is crucial to the development of more and better drugs. At present the determination of protein atomic structure, as well as the atomic structure of other molecules, is performed mainly by X-ray crystallography (which requires a three-dimensional crystal of protein), electron cryomicroscopy (a slow and difficult method usually requiring two-dimensional crystals) and NMR, a new method most useful for small proteins, currently under development, in which months of work may be needed for each protein structure. The overwhelming majority of proteins solved so far have been solved by X-ray crystallography. However, the preparation of protein crystals is a slow, tedious and poorly understood process, which is often unsuccessful. Of the approximately one million proteins in the human organism, only a small percentage have been solved, and there is thus a crucial need for new and rapid non-crystallization-based methods for solving molecular structures at atomic or near-atomic resolution. The need is particularly urgent for membrane proteins, since 70% of drug molecules interact with a membrane protein, and these proteins are the most difficult to crystallize. It is believed that many proteins can never be crystallized.

### SUMMARY OF THE INVENTION

In one aspect, the present invention provides methods for molecular structure determination, comprising:

(a) generating a hydrated molecule beam at a temperature of 200K or below within a vacuum chamber;

(b) passing the hydrated molecule beam through a laser beam and a diffracting beam to produce a diffraction pattern for a first alignment of a plurality of molecules in the hydrated molecule beam;

(c) passing the hydrated molecule beam through the laser beam and the diffracting beam to produce a diffraction pattern for a second alignment of a plurality of molecules in the hydrated molecule beam;

(e) repeating step (c) a desired number of times to produce diffraction patterns of further alignments of a plurality of the molecules in the hydrated molecule beam; and

(f) determining a structure of the molecule from a plurality of the diffraction patterns obtained from different alignments of the molecule.

In a preferred embodiment, the hydrated molecule beam comprises hydrated molecules in vitreous ice. In a further preferred embodiment, the hydrated molecule beam comprises a monodirectional stream of individual ice-jacketed molecules. In a still further embodiment, each individual ice-jacketed molecule has a diameter of 1 μm or less.

In a further embodiment, passing the hydrated molecule beam through a laser beam and a diffracting beam comprises simultaneous intersection of all three beams in an intersecting volume. In another embodiment, passing the hydrated molecule beam through a laser beam and a diffracting beam comprises:

(a) passing the hydrated molecule beam through a laser beam to produce a first alignment of the molecules in the hydrated molecule beam, wherein the first alignment comprises a plurality of the molecules with a first alignment;

(b) passing the first alignment of the molecules through a diffracting beam to produce a diffraction pattern of the first alignment of the molecules;

(c) passing the hydrated molecule beam through the laser beam to produce a second alignment of the molecules in the hydrated molecular beam, wherein the second alignment comprises a plurality of the molecules with a second alignment;

(d) passing the second alignment of the molecules through the diffracting beam to produce a diffraction pattern of the second alignment of the molecule; and

(e) repeating steps (c-d) a desired number of times to produce diffraction patterns of further alignments of a plurality of the molecules in the hydrated molecule beam.

In various further embodiments, the laser beam produces a linear polarized laser field, an elliptical polarized laser field, or a circular polarized laser field.

In further preferred embodiments, the molecule comprises a protein or a macromolecular assembly.

In a second aspect, the present invention provides a device for carrying out serial diffraction, comprising:

(a) a vacuum chamber;

(b) a diffracting beam source in fluid communication with the vacuum chamber;

(c) a laser beam source in fluid communication with the vacuum chamber;

(d) a hydrated molecule beam source in fluid communication with the vacuum chamber;

(e) a temperature control system for maintaining a temperature in the vacuum chamber of 200K or less; and

(f) a detector system in connection with the vacuum chamber;

wherein the diffracting beam source, the laser beam source, and the hydrated molecule beam source are positioned to permit beams directed from the diffracting beam source, the laser beam source, and the hydrated molecule beam source to intersect in the vacuum chamber in an intersecting volume of between 10 μl and 100 μL; and wherein the detector system is positioned so as to receive diffraction patterns from molecules in the molecule beam passing through the diffracting beam.

In a third aspect, the present invention provides methods for transferring proteins from a liquid solution into vacuum, comprising (a) providing a hydrated protein solution in a capillary tube at approximately room temperature;

(b) passing the hydrated protein solution through a nozzle in the capillary tube and into a gas tube volume, wherein a co- or counter-flowing gas is flowed into the gas tube volume to form a monodirectional stream of individual vitreous ice protein droplets;

(c) passing the monodirectional stream of individual vitreous ice protein droplets from the gas tube into an inlet aperture of an injection tube, wherein temperature and pressure conditions in the injection tube maintain the monodirectional stream of individual vitreous ice protein droplets; and

(d) passing the monodirectional stream of individual vitreous ice protein droplets through the injection tube into a vacuum chamber.

### BRIEF DESCRIPTION OF THE FIGURES

FIG. 1 is a diagram of an exemplary apparatus for performing serial diffraction. Parts list for FIG. 1:

1 Vacuum Chamber outline

2 Laser for molecular alignment (IR CW Fiber laser, 100W, 1 micron wavelength)

3 Positioning device for alignment of laser beam, laser window and quarter wave plate polarizer

4 LN₂ cooled beam dump for droplet beam helps keep the vacuum <10⁻⁶ Torr

5 LN₂ feedthrough for cryoshield. The cryoshield prevents condensation from reaching the cooled CCD chip.

6 CCD camera

7 Protein injection device

8 Laser beam for molecular alignment

9 Ice-jacketed protein beam

10 Diffracting particle beam

11 In vacuum lens with positioning motors to focus alignment laser onto protein beam

12 Motors for protein beam alignment (allow movement of injection nozzle)

13 Observation port for visible alignment laser (a visible laser co aligned with the IR laser can be used to align the laser optics to the droplet beam)

14 Water-cooled infra-red laser beam dump

15 CCD camera readout and water-cooling

### DETAILED DESCRIPTION OF THE INVENTION

All publications, patents and patent applications cited herein are hereby expressly incorporated by reference for all purposes.

As used herein, the singular forms “a”, “an” and “the” include plural referents unless the context clearly dictates otherwise.

In a first aspect, the present invention provides methods for molecular structure determination, comprising:

(a) generating a hydrated molecule beam at a temperature of 200K or below within a vacuum chamber;

(b) passing the hydrated molecule beam through a laser beam and a diffracting beam to produce a diffraction pattern for a first alignment of a plurality of molecules in the hydrated molecule beam;

(c) passing the hydrated molecule beam through the laser beam and the diffracting beam to produce a diffraction pattern for a second alignment of a plurality of molecules in the hydrated molecule beam;

(e) repeating step (c) a desired number of times to produce diffraction patterns of further alignments of a plurality of the molecules in the hydrated molecule beam; and

(f) determining a structure of the molecule from a plurality of the diffraction patterns obtained from different alignments of the molecule.

In this first aspect, the present invention provides novel methods to promote non-crystallization-based molecular structure determination involving “serial diffraction.” Instead of arranging the molecule, such as a protein, in a three-dimensional periodic array (a crystal), the present methods comprise passing a hydrated beam comprising many copies of the molecule at low temperatures across a high energy diffracting beam, such as a high energy electron or X-ray beam, which produces a scattering (diffraction) pattern. The molecules of the hydrated beam are aligned by a laser beam so that each molecule is substantially identically aligned. As used herein, “substantially identically aligned” means that the degree of alignment is sufficient to provide a useful reconstructed image of the average molecular structure from the diffraction patterns. Since there may be many aligned molecules in the diffracting beam at any instant, one obtains an average structure from all of these, and the exposure time is reduced by this number. Due to the radiation sensitivity of proteins to electron or X-ray beams, it is not possible to obtain a diffraction pattern from a single molecule without destroying it. Thus, the cumulative effect of scattering from many molecules (continually being replenished by the hydrated molecule beam), each subjected to a sub-critical dose of the diffracting beam as it passes through is used. (The “critical dose” is the radiation dose which destroys features of a given size.) The method comprises collecting diffraction patterns for a plurality of molecular alignments by changing the orientation of the laser beam's polarization. These methods provide substantial improvement over previous methods for molecular structure determination.

The methods of the invention can be used with any molecule that can be aligned by a laser beam (ie: all molecules possessing an anisotropic polarizability or non-spherical shape). In a preferred embodiment, the molecules comprise proteins; in another embodiment, the molecules comprise proteins bound to a ligand of interest. In a further embodiment, the molecule comprises macromolecular assemblies.

As is well known in the art, a vacuum chamber is a device to create a partial volume of space that is empty of matter and radiation, including air, so that gaseous pressure is much less than standard atmospheric pressure. Any such vacuum chamber can be used in conjunction with the methods of the invention, so long as a temperature of 200K or below in the vacuum chamber can be maintained.

The methods of this first aspect of the invention are conducted at cryogenic temperatures of 200K or below. The molecules must be cold, in order to facilitate alignment. The specific temperature used depends on the properties of the molecules being analyzed (size, anisotropy, polarizablility) and on the power of the focused laser alignment beam, and ranges from near room temperature for viruses such as tobacco mosaic virus (TMV) down to only a few degrees K for small proteins such as lysozyme. As taught by Faubel, [M. Faubel, et al., Z. Phys. D 10, 269-277 (1988)], water droplets cool extremely rapidly in vacuum, reaching temperatures as low as 200 K, which would give access to the upper end of this range. To reach lower temperatures it is preferred to pass the jacketed proteins through a cryogenic gas to induce additional cooling, as is well known in the art. A more detailed discussion of temperature considerations is provided in the examples below.

The preparation of molecular beams is described in texts such as H. Pauly, Atomic Molecular Cluster Beams, Springer 2000, First Edition, Vol. 1, p. 149 section 4.1. 1, incorporated herein by reference. A protein displays its native conformation only when hydrated. Generally, a water film only a few molecules thick is needed. Under standard conditions of protein study, this water film (or “jacket”) is in the liquid water. However, it is known from cryomicroscopy of proteins that a jacket of amorphous or vitreous ice can also maintain the native protein conformation. Crystalline ice is to be avoided, though, as its formation disrupts protein structure. (“Cryoprotectants” can be added to the protein solution to suppress formation of crystalline ice.) Thus, in a preferred embodiment of this first aspect, the hydrated molecule beam comprises hydrated molecules in vitreous ice. “Vitreous” refers to a material in a glassy state, wherein the constituent atoms do not exhibit the long-range order that is characteristic of crystals, but do exhibit short-range order, and wherein the separation of atoms and/or the lengths of covalent bonds are very close to their typical equilibrium distances. The formation of vitreous rather than crystalline ice (due to the cryoprotectant and/or rapid cooling) is highly preferred to prevent denaturing of proteins. Electron diffraction from a beam of crystalline ice-balls is described in L. Bartell, J. Phys. Chem. 98, p. 7455 (1994), incorporated herein by reference.

Thus, it is preferred that an adequate coating of water or non-crystalline ice be maintained around each individual protein molecule at all times. In addition, the injection process preferably does not subject the protein to thermal or mechanical stress in any degree that would denature the protein. To allow experimental interrogation of individual molecules once in the vacuum chamber, it is highly desirable that they form a mono-directional (single-file) molecule beam, and thus be physically separated from one another within this beam. In fact, these objectives can be achieved by simple laminar flow of a protein solution through a microscopic aperture into vacuum, as is known in the art.

In a further embodiment, the hydrated molecule beam comprises a monodirectional stream of individual ice-jacketed molecules. The ice is vitreous or glassy. The ice jacket may range in thickness from several micrometers down to less than one nanometer. The molecules, such as proteins, are preferably jacketed by water or vitreous ice at all times and not subjected to high pressures or temperatures. The allowable pressures and temperatures depend critically on, for example, the individual molecule and the pH of the solution, but it appears that pressures above a few kbar and temperatures significantly above room temperature (but still well below the boiling point of water) will denature most proteins as taught by Hummer et al. [G. Hummer, et al., Proc. Natl. Acad. Sci. USA, 95, 1552-1555 (1998)] and by Heremans and Smeller [K. Heremans and L. Smeller, Biochimica et Biophysica Acta B1386B, 353-370 (1998)].

The ice-jacket is preferably thin, with a diameter of between 0.2 nm and 1 μm, and preferably between 1 nm and 1 μm, both to facilitate rapid rotation to the desired aligned orientation as well as to maximize penetration of the diffraction beam. Penetration depths of x-rays and electrons, through water and proteins are known [NIST databases: http://physics.nist.gov/PhysRefData/Xcom/Text/XCOM.html and http://physics.nist.gov/PhysRefData/Star/Text/contents.html, respectively] and droplet diameters for these diffracting beams of up to 1 micrometer and 100 nanometer, respectively, are highly preferred. In a preferred embodiment, submicron-sized ice-jackets are produced by generating submicron-sized small droplets by use of submicron-sized beam nozzles. Alternatively, submicron-sized ice-jackets can be generated by evaporatively shrinking larger droplets by passing them through a warm, high pressure gas. Standard electrospray practice teaches how to do this, but only with charged droplets that do not follow a single-file trajectory. To shrink droplets that may not be charged and to do so without deflecting the droplets from a single-file trajectory, the preferred embodiment is a coaxially-flowing gas that surrounds and flows parallel to the ice- or water-jacketed protein stream and which is adjustable in flow velocity from under 1 m/s to over 100 m/s and in temperature from below room temperature to over 100° C.

It is also preferred to control the charge on the ice-jacketed proteins. Standard inkjet practice teaches how to inductively charge droplets by placing an electric potential on the droplet nozzle. Kostiuk and Kwok (L. W. Kostiuk and D. Y. Kwok, International Patent Application Number PCT/CA2004/001435) teach that a fluid flowing through a channel charges by electrokinetic effects even in the absence of an applied electric potential. A preferred embodiment to control electrokinetic charging is inductive charging controlled by a feed-back loop that measures the current flow in the single-file stream of ice-jacketed proteins.

In a further preferred embodiment, a large number of molecules (up to many millions per second) are passed through a small volume in space (the “alignment volume”) defined by the focused alignment laser beam. The larger the flux of molecules through this alignment volume, the higher the total diffracted intensity and the shorter the measurement time. In a preferred embodiment, the alignment volume is between 5-30 micrometers on a side (more preferably between 5-15 micrometers on a side), and the transverse width of the ice-jacketed molecule beam is no larger than this. Accordingly, a monodisperse, monodirectional, single-file droplet beam is used, such as taught by Rayleigh [Lord Rayleigh, Proc. Roy. Soc. London, A 29, 71-97 (1879).

The methods of this first aspect comprise passing the first hydrated molecule beam through a laser beam and a diffracting beam. There is no time dependence, and thus any process that provides laser beam-aligned molecules in a diffracting beam can be used. One embodiment comprises simultaneous intersection of all three beams in an “intersecting volume,” which includes the alignment volume discussed above. In another embodiment, laser alignment of the molecules occurs first, followed by passing the aligned molecules through the diffracting beam. In this embodiment, passing the hydrated molecule beam through a laser beam and a diffracting beam comprises:

(a) passing the hydrated molecule beam through a laser beam to produce a first alignment of the molecules in the hydrated molecule beam, wherein the first alignment comprises a plurality of the molecules with a first alignment;

(b) passing the first alignment of the molecules through a diffracting beam to produce a diffraction pattern of the first alignment of the molecules;

(c) passing the hydrated molecule beam through the laser beam to produce second alignment of the molecules in the hydrated molecular beam, wherein the second alignment comprises a plurality of the molecules with a second alignment;

(d) passing the second alignment of the molecules through the diffracting beam to produce a diffraction pattern of the second alignment of the molecule; and

(e) repeating steps (c-d) a desired number of times to produce diffraction patterns of further alignments of a plurality of the molecules in the hydrated molecule beam.

The methods of the first aspect of the invention comprise passing hydrated molecule beams through a laser beam. Any laser source can be used, so long as the resonant absorption of laser beam energy by ice-jacketed molecules is avoided. Optical alignment of molecular beams is described in H. Stapelfeldt, Review of Modem Physics, Vol. 75, p. 543, 2003, incorporated herein by reference. In a preferred embodiment, an infrared laser beam is used. In a more preferred embodiment, a continuous (CW) laser source, such as a fiber laser, is used, operating at a wavelength of about one micron, where resonant absorption of laser-beam energy by the ice-jacketed molecules is avoided. The laser intensity and temperature needed to achieve a given degree of alignment are discussed in detail in the examples below, and depend at least on the size of the molecule, its shape, and the resolution required in the final reconstructed image of the molecule. Useful results can be obtained, for example, with CW infrared lasers whose power is greater than fifty watts. However, it will be understood that other wavelengths of laser light can also be used, where the wavelength of the -laser light is chosen such that resonant absorption of laser beam energy by ice-jacketed molecules is avoided. Alignment power may be wavelength-dependent. In a preferred embodiment, the upper limit on laser power density is approximately 5×10¹⁴W/cm². (Larsen, PRL 85 (12) 2000 p. 2470) It will also be understood that lasers other than fiber lasers can be used. Examples of lasers include, but are not limited to, semiconductor lasers, solid state lasers such as flashlamp pumped lasers or laser-diode-pumped solid state lasers (such as Nd:YAG or the like), and gas lasers. It will also be understood that arrays of lasers can also be used.

It will also be understood that pulsed lasers can also be used. Operation of pulsed lasers and pulse rates are known in the art and can have different pulse lengths and pulse repetition frequencies. When using pulsed lasers, it is preferred that the diffraction patterns are obtained only from time periods wherein the laser pulse is “on” and molecules in the hydrated molecule beam are thus aligned.

The methods of the invention can utilize any laser source as described above, including those placed within the vacuum chamber, or external to the vacuum chamber. Laser beams from such external laser sources can be introduced into the vacuum chamber by any suitable means known in the art, including but not limited to, a fiber-optic feedthrough, a light pipe feedthrough, and a window port of a vacuum chamber that is transparent to the wavelength of the laser light. Additional optics (which could be inside the vacuum or outside the vacuum), such as lenses, may also be used with the laser to control where the beam interacts with the molecules.

It is known in the art that intense laser fields can align molecules along a given space-fixed axis, force them to a plane, or eliminate their rotations altogether, by choice of the polarization to linear, circular, or elliptical, respectively.

A strong linearly polarized laser pulse of sufficiently long duration can align the largest polarizable axis of a molecule along a given direction fixed in space. It is also possible to achieve three-dimensional alignment of the direction (but not the sense) of all axes of a polyatomic molecule by using an elliptically polarized laser field. The 3D alignment is generally applicable to molecules that possess different polarizabilities along three molecular axes, which in turn depends on the molecular shape for a homogeneous dielectric. The ellipticity necessary to optimize the degree of alignment depends on the specific polarizability tensor and molecular shape. “Sense” means the “direction” along a given line—eg north or south on a road which runs in a north-south direction. The ambiguity of sense means, for example, that laser-alignment using linear polarization creates equal populations of molecules which are erect and those which are upside down - these have the same energy in the laser field. This leads, in three-dimensions, to six possible orientations for molecules aligned with elliptically polarized light. This ambiguity does not prevent the diffraction data from being used to provide a correct three-dimensional map of the molecular structure.

As used herein, “aligned” means a defined order of the molecular geometry with respect to a space-fixed axis. The set of molecules within the diffracting beam are aligned to within an accuracy of a few degrees or better. This accuracy depends on the laser power, the temperature and the size and shape of the molecules, as discussed above and in more detail in the examples below. The resolution of the final three-dimensional reconstructed image of the molecule is approximately equal to this angular spread multiplied by half the length of the molecules, and may be less than one nanometer under the conditions described elsewhere in this document. As the spread is increased (due, for example, to an increase in temperature), the resolution of the final image of the molecule becomes degraded. In general, for a given molecule, the degree of (adiabatic) alignment can be optimized by increasing the intensity of the alignment field or by lowering the rotational temperature of the molecule.

In one non-limiting example, a large molecule (such as a ribosome) with an assumed dielectric constant of K=4 passing through a 100W CW laser focus of 10 micron diameter is cooled to approximately 80K to achieve an an alignment error corresponding to a resolution of 0.7 nm. In a further non-limiting example, a small molecule (such as lysozyme) under the same conditions is cooled to approximately 10K to achieve the same alignment error.

In another exemplary embodiment, a droplet beam velocity of 50 m/sec or less is used, in combination with a CW laser power of 100 W at one micron wavelength, and an interaction volume for the three beams of ten microns on a side.

Based on the teachings herein, those of skill in the art can optimize conditions for molecular structure determination of any molecule of interest.

As will be understood by those of skill in the art, a “second alignment” or “further alignments” of the molecule are alignments that differ from the first alignment, by changing the orientation of the laser beam's polarization.

In a further preferred embodiment of this first aspect, passing the hydrated molecule beam through a laser beam within the vacuum chamber to produce a plurality of aligned hydrated molecule beams comprises rotating the laser beam in steps about the hydrated molecule beam to repeatedly change the alignment of the molecules in the hydrated molecule beam. Any number of steps can be used. In various embodiments, the method comprises rotating the laser beam to obtain 2, 3, 6, 18, 45, 90, or 180 alignments of the molecules, or as many as are needed for the desired resolution, as understood by those skilled in the art of tomography.

The methods of the invention comprise passing aligned molecules in the hydrated molecule beams through a diffracting beam to produce a diffraction pattern of the aligned molecules. The diffracting beam can be any coherent diffracting beam, such as a high energy electron or X-ray beam, wherein “high energy” means energy high enough so that the wavelength is smaller than the molecule so that it will diffract. The diffracting beam can comprise continuous or pulsed diffracting beams. For example, a synchrotron can be used to provide a source of pulsed X-ray beams. Pulsing the X-ray beam with many molecules in the intersection volume at once can be used, for example, to study the time dependence of electronic processes in a molecule, with the great advantage of increased signal due to many molecules diffracting at once. So long as a pulse is generated to analyze at least two of the molecules in the intersecting volume, a pulsed diffracting beam can be used, preferably in combination with synchronization.

In one preferred embodiment, the diffracting beam comprises an electron beam generated from an electron source. In a further preferred embodiment of this first aspect, a magnetic lens is used to focus the electron beam generated at the electron source. In a still further preferred embodiment of this first aspect, beam deflectors direct the electron beam to intersect the aligned hydrated molecule beam at a desired site.

As noted above, due to the radiation sensitivity of proteins to electron or X-ray beams, it is not possible to obtain a diffraction pattern from a single molecule without destroying it, and thus the methods comprise determining the cumulative effect of scattering of many molecules, each subjected to a sub-critical dose of the diffracting beam. Such a “sub-critical dose” depends on at least the molecule being analyzed and the desired resolution. For example, the resolution needed to see the fold of a protein is approximately 0.7 nm. Determination of the sub-critical dose is well known to those of skill in the art.

The resulting diffraction patterns can be acquired using any appropriate detection system, including but not limited to existing X-ray and electron-area detector systems, which are well known in the art and are described in more detail below. In a further preferred embodiment of this first aspect, determining a structure of the molecule from the plurality of diffraction patterns obtained from different alignments of the molecule comprises combining the plurality of diffraction patterns to form a three-dimensional pattern of the molecule. The structures can be solved, for example, using these electron diffraction patterns and new iterative solutions to the phase problem (described in S. Marchesini et al., Phys. Rev. B68, P. 140101R (2003) incorporated herein by reference), together with the heavy-atom method. Charge-density maps can be obtained for many orientations of the molecule (controlled by the laser polarization), and synthesized tomographically to generate a three-dimensional view.

Imaging proteins in this fashion is an important step in drug design. Images of the protein with and without a docked drug molecule at one of its receptors can help determine what drugs are candidates for protectively blocking receptors susceptible to virus reception.

One advantage of the methods of this first aspect of the invention over X-ray crystallography is that it is not necessary to form crystals. One advantage of the methods of this first aspect of the invention over one form of cryomicroscopy is that that the current methods are not restricted to proteins that form two-dimensional crystals, and they involves much simpler and more rapid data acquisition than electron cryomicroscopic imaging of macromolecules.

In a second aspect, the present invention provides devices for carrying our serial diffraction, comprising:

(a) a vacuum chamber;

(b) a diffracting beam source in fluid communication with the vacuum chamber,

(c) a laser beam source in fluid communication with the vacuum chamber;

(d) a hydrated molecule beam source in fluid communication with the vacuum chamber;

(e) a temperature control system for maintaining a temperature in the vacuum chamber of 200K or less; and

(f) a detector system in connection with the vacuum chamber;

wherein the diffracting beam source, the laser beam source, and the hydrated molecule beam source are positioned to permit beams directed from the diffracting beam source, the laser beam source, and the hydrated molecule beam source to intersect in the vacuum chamber in an intersecting volume of between 10 μl and 100 μL; and wherein the detector system is positioned so as to receive diffraction patterns from molecules in the molecular beam passing through the diffracting beam.

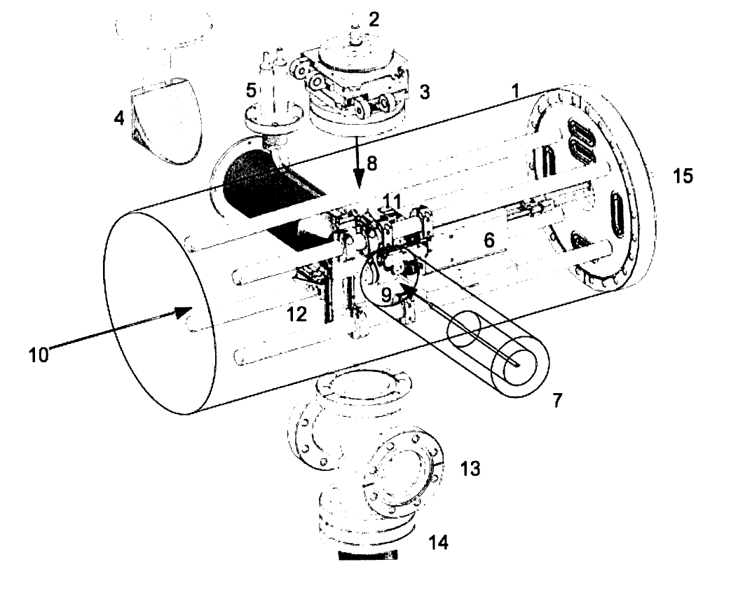

A non-limiting example of a device for carrying out the methods of the invention is provided in FIG. 1. The outline of the vacuum chamber (1) is shown. As is well known in the art, a vacuum chamber is a device to create a partial volume of space that is empty of matter and radiation, including air, so that gaseous pressure is much less than standard atmospheric pressure. Any such vacuum chamber can be used in conjunction with the methods of the invention, so long as a temperature of 200K or below in the vacuum chamber can be maintained.

A laser source is provided that is in fluid communication with the vacuum chamber. As used herein, the term “in fluid communication with” means a connection that permits the passage of liquids, gases, electrons, or photons between the recited components. The laser source may comprise a docking port for attachment of an external laser source, may comprise the docking port and the external laser source, or may comprise a laser source within (either partially or completely) the vacuum chamber. FIG. 1 shows an exemplary external laser source (2) is shown in fluid communication with the vacuum chamber. In the example, the laser source (2) is an infrared continuous fiber laser of 100 W and 1 micron wavelength. Laser beams from such external laser sources can be introduced into the vacuum chamber by any suitable means known in the art, including but not limited to, a fiber-optic feedthrough, a light pipe feedthrough, and a window port of a vacuum chamber that is transparent to the wavelength of the laser light. Additional optics (which could be inside the vacuum or outside the vacuum), such as lenses, may also be used with the laser to control where the beam interacts with the molecules. In the example provided in FIG. 1, the external laser source (2) comprises a positioning device, laser window and quarter wave plate (3) for producing elliptically polarized laser fields.

A laser beam (8) is produced from the laser source and passes into the vacuum chamber (1). In this example, directly opposite the entry point of the laser beam into the vacuum chamber is a laser dump (14), in this case a water-cooled infra-red laser beam dump, to capture the beam after passage through the intersecting volume. In this example, the laser beam dump (14) is internal to the vacuum chamber but water-cooled from the outside, with heat transferred across a vacuum seal. While preferably placed directly opposite the laser source, the laser beam dump can be placed at any position from which it can collect the laser beam after passage through the intersecting volume. The laser dump can further comprise an observation port.

As noted above in the first aspect of the invention, any laser source can be used, so long as the resonant absorption of laser beam energy by ice-jacketed molecules is avoided. In a preferred embodiment, an infrared laser beam is used. In a more preferred embodiment, a continuous (CW) laser source, such as a fiber laser, is used. It will also be understood that lasers other than fiber lasers can be used. Examples of lasers include, but are not limited to, semiconductor lasers, solid state lasers such as flashlamp pumped lasers or laser-diode-pumped solid state lasers (such as Nd:YAG or the like), and gas lasers. It will also be understood that arrays of lasers can also be used. It will also be understood that pulsed lasers can also be used.

It is highly preferred that the laser beam polarization can be rotated in steps about the beam of molecules to repeatedly change the alignment of the molecules so that diffraction patterns are accumulated from many aligned molecules at each new orientation. In a preferred exemplary embodiment the laser beam polarization can be rotated in 1° increments throughout 180° using a quarter-wave plate, as is well known to those skilled in the art of laser optics, to form 180° different diffraction patterns. The quarter-wave plate, which controls polarization of the laser, is situated near the laser beam positioning device (3) in FIG. 1. These different diffraction patterns are subsequently combined to form a three dimension map of the diffraction pattern of the molecule. Any means by which such rotation of the laser beam polarization can be carried out can be used with the present invention. In another embodiment, the laser beam source itself can be rotated relative to the intersecting volume.

The laser beam-dump (14) device may also comprise an observation port (13) in FIG. 1 for a visible alignment laser (13). For example, a visible laser co-aligned with the infrared laser can be used to align the laser optics to the droplet beam. This beam (with the powerful infrared laser switched off) can safely be observed by eye through the window at 13, which views an inclined mirror, directing the view up into the visible laser coming down from 8 when a droplet beam crosses this visible laser beam, it produces a characteristic scattering pattern on a semi-transparent viewing screen inserted horizontally in the upper neck of the “cross” 13. By adjusting the lateral position and focus of the laser beam for the strongest such scattering pattern (known in the art of optics as a “Fraunhoffer diffraction pattern”), the visible laser (and therefore the co-aligned infra-red laser) can be aligned with the droplet beam.

The hydrated molecule beam source may comprise a docking port for attachment of an external hydrated molecule beam source source, may comprise the docking port and the external hydrated molecule beam source, or may comprise a hydrated molecule beam source within (either partially or completely) the vacuum chamber. In the example shown in FIG. 1, the hydrated molecule beam source comprises a protein injection device (7) in fluid communication with the vacuum chamber. The protein injection device produces a hydrated molecule beam (9) (in this case, an ice-jacketed protein beam). In this example, a proximal end of the hydrated molecule beam source is external to the vacuum chamber. The proximal end of the hydrated molecule beam source is preferably in fluid communication with a reservoir source comprising, for example, a pressurized supply of molecules in a mixture of cryoprotectant and water. A distal end of the hydrated molecule beam source is internal to the vacuum chamber, corresponding to a site for release of the hydrated molecule beam to the intersecting volume within the chamber. This hydrated molecule solution can then be sprayed through a microscopic aperture in a droplet nozzle into vacuum, where evaporation and expansion causes small balls of vitreous ice to form, each containing a molecule. The hydrated molecule beam can be cooled further by, for example, helium gas at 4K before entering the vacuum chamber, and the molecules and are given identical orientations by passage through the laser beam before or while passing across the electron beam.

While this exemplary arrangement of the hydrated molecule beam source is preferred, any suitable arrangement of the hydrated molecule beam source that provides a hydrated molecule beam to the intersecting volume in the vacuum chamber can be used with the device. Any protein injection device known in the art can be used (See, for example, H. Pauly, Atomic Molecular Cluster Beams, Springer 2000, First Edition, Vol. 1, p. 149 section 4.1.1; A. Frohn and N. Roth, “Dynamics of droplets”. Springer, Berlin, (2000) and A. Lindinger, J. P. Toennies and A. F. Vilesov, J. Chem Phys. Vol 110, p. 1429 (1999) incorporated herein by reference..

In a preferred embodiment, the hydrated molecule beam source can maintain the molecule of interest, such as proteins, in ajacket of amorphous or vitreous ice. It is further preferred that the hydrated molecule beam source does not subject the molecule to thermal or mechanical stress in any degree enough to denature the molecule, such as a protein. It is further preferred that the hydrated molecule beam source produces a mono-directional (single-file) molecule beam, as discussed above. As is known to those of skill in the art, these objectives can be achieved by simple laminar flow of a protein solution through a microscopic aperture (such as a nozzle) in the hydrated molecule beam source and into vacuum. It is also preferred to control the charge on the ice-jacketed proteins produced by the hydrated molecule beam source. Standard inkjet practice teaches how to inductively charge droplets by placing an electric potential on the droplet nozzle, and Kostiuk and Kwok (L. W. Kostiuk and D. Y. Kwok, International Patent Application Number PCT/CA2004/001435) teach that a fluid flowing through a channel charges by electrokinetic effects even in the absence of an applied electric potential. Thus, in a preferred embodiment, the nozzle on the hydrated molecule beam source comprises an electric potential source.

FIG. 1 also shows the inclusion of a liquid nitrogen cooled hydrated molecule beam dump (4) to collect hydrated molecules after passing through the intersecting volume. This dump also serves to maintain the desired vacuum level in the vacuum chamber. While preferably placed directly opposite the hydrated molecule beam source, the hydrated molecule beam dump can be placed at any position from which it can collect the hydrated molecule beam after passage through the intersecting volume.

As the hydrated molecule beam passes through the vacuum chamber, evaporation occurs. Thus, the device may further comprise a cryoshield (not numbered; directly below (5)) to prevent buildup of condensation, which can damage, for example, portions of the detector system (6) and (15). Such a cryoshield preferably comprises a cooling source, such as a liquid nitrogen source (5).

In the example shown in FIG. 1, the diffracting beam source (10) is external to and in fluid communication with the vacuum chamber. The diffracting beam source may comprise a docking port for attachment of an external diffracting beam source, may comprise the docking port and the external diffracting beam source, or may comprise a diffracting beam source within (either partially or completely) the vacuum chamber. The diffracting beam source can be comprise any coherent diffracting beam source, such as a high energy electron or X-ray beam, wherein “high energy” means an energy high enough so that the wavelength is smaller than the molecule so that it will diffract. The diffracting beam can comprise continuous or pulsed diffracting beams. For example, a synchrotron can be used to provide a source of pulsed X-ray beams. Pulsing the X-ray beam with many molecules in the intersection volume at once can be used, for example, to study the time dependence of electronic processes in a molecule, with the great advantage of increased signal due to many molecules diffracting at once. So long as a pulse is generated to analyze at least two of the molecules in the intersecting volume, a pulsed diffracting beam can be used, preferably in combination with synchronization.

In one preferred embodiment, the diffracting beam comprises an electron beam generated from an electron source. In a further preferred embodiment of this first aspect, a magnetic lens is used to focus the electron beam generated at the electron source. In a still further preferred embodiment of this first aspect, beam deflectors direct the electron beam to intersect the aligned hydrated molecule beam at a desired site, and the size of the diffraction (scattering) pattern formed by the electron is magnified by magnetic lenses, well known to those skilled in the art of electron optics.

The device further comprises a detector system in connection with the vacuum chamber. Any type of detection system capable of detecting and recording molecule diffraction patterns can be used, including but not limited to existing X-ray and electron area-detector systems, which are well known in the art. An exemplary detector system is shown in FIG. 1, comprising a phosphor screen (or similar) (15) coupled by fiber optics to an area detector such as a charge coupled device (6). A computer connected to the detector can then be used to assemble the many two-dimensional diffraction patterns into one three-dimensional pattern. This three-dimensional pattern is then converted into a three-dimensional map of charge-density showing the atomic arrangement using the iterative algorithm of Marchesini and others in Phys. Rev. B68, PAGE 140101 (2003), and its three-dimensional extensions (taught, for example, by Millane (J. Opt. Soc. Am. A13, P. 725 (1996), incorporated herein by reference and attached) to solve the phase problem for the continuous distribution of scattering from an isolated object. Each diffraction pattern formed at each step is formed by numerous molecules diffracting the diffracting beam, such as a collimated electron beam, so that an image of sufficient detail (resolution) and contrast can be reconstructed after passing these diffraction patterns through an iterative phasing algorithm (described in Marchesini et al.). Examples of electron diffraction patterns from partially aligned molecules in a molecular beam are to be found in K. Hoshina et al., J. Chem. Phys., 118, p. 6211 (2003), incorporated by reference and attached. Magnetic lenses can be used to focus the electron beam generated at an electron source. Beam deflectors can direct the beam to intersect the molecule beam.

The device comprises a temperature control system for maintaining a temperature in the vacuum chamber of 200K or less. There are no limitations on the type of system employed, so long as it can keep the vacuum chamber at a temperature of 200K or less. As taught by Faubel, [M. Faubel, et al., Z. Phys. D 10, 269-277 (1988)], water droplets cool extremely rapidly in vacuum, reaching temperatures as low as 200 K, which would give access to the upper end of this range. To reach lower temperatures it is preferred to pass the jacketed proteins through a cryogenic gas to induce additional cooling, as is well known in the art.

The device is configured so that beams directed from the diffracting beam source, the laser beam source, and the hydrated molecule beam source intersect in the vacuum chamber in an intersecting volume of between 10 and 100 μL; and wherein the detector system is positioned so as to receive diffraction patterns from molecules in the molecular beam passing through the diffracting beam. In a preferred embodiment, the device further comprises positioning means located with the vacuum chamber, for precise positioning of the beams. In one embodiment, the positioning means comprises electrical motors. One such electrical motor is used to focus the laser beam at the same height as the hydrated molecule beam. (See FIG. 1: the lateral position of the laser beam is adjusted by motors (3) which move it sideways). Other motors inside the chamber are positioned to move the hydrated molecule beam as needed, for example in two orthogonal directions. In a further embodiment, the entire vacuum chamber itself may be moved by external positioning screws to provide needed beam positioning, such as centering the diffracting beam along the axis of the vacuum chamber. It is further preferred that the positioning means is controlled by signals from a computer connected to the vacuum chamber by electrical feedthroughs, as is well known to those skilled in the art of vacuum electronics.

In a further preferred embodiment, the device further comprises a beam-stop inside the vacuum chamber, which can also be moved by internal motors. The beam stop can be positioned, for example, in the center of the area detector (6) to prevent it being overloaded by the unscattered portion of the diffracting beam.

Any embodiments of diffracting beam sources, laser beam sources, hydrated molecule beam sources, vacuum chambers, temperature control means for producing a temperature in the vacuum chamber of 200K or less, and detector systems described above in the first aspect of the invention can be used with the device of the second aspect of the invention., and all embodiments of the first aspect of the invention can be used in conjunction with the second aspect of the invention.

A protein must fold into a specific structure in order to become biologically active. This “native” conformation presumably corresponds to a global minimum in the free energy of the protein structure, yet energy barriers to reconfiguration are low and can be surmounted at energies only slightly above room temperature (an egg cooks at 373 K, only 60 K above body temperature). It is the structure of the biologically active, folded, native protein that is of primary interest and care must be taken not to alter this configure (“denature” the protein) during the structure determination.

In the methods disclosed above, one concern is transferring proteins from a liquid solution into vacuum without denaturing the protein. Thus, in a third aspect, the present invention provides methods for transferring proteins from a liquid solution into vacuum, comprising

(a) providing a hydrated protein solution in a capillary tube at approximately room temperature;

(b) passing the hydrated protein solution through a nozzle in the capillary tube and into a gas tube volume, wherein a co- or counter-flowing gas is flowed into the gas tube volume to form a monodirectional stream of individual vitreous ice protein droplets;

(c) passing the monodirectional stream of individual vitreous ice protein droplets from the gas tube into an inlet aperture of an injection tube, wherein temperature and pressure conditions in the injection tube maintain the monodirectional stream of individual vitreous ice protein droplets; and

(d) passing the monodirectional stream of individual vitreous ice protein droplets through the injection tube into a vacuum chamber.

The use of the co- or counter-flowing gas in the gas tube volume is to alter the temperature, size, and/or electrical charge state of the protein in the hydrated protein solution so as to form vitreous ice droplets. Such vitreous ice droplets are described in detail above.

This third aspect of the invention provides methods to inject solvated, un-denatured proteins into vacuum, such as ultra-high vacuum (UHV); rapidly cool the solvated proteins as part of this UHV injection, thereby “quenching in” their native conformation; generate a periodic, monodisperse, monodirectional stream of proteins that can be phase-locked to an external signal; encase each protein in a protective hydration shell though the UHV injection; and attain very low temperatures (˜500 mK) in the injected, hydrated proteins.

The methods of this third aspect of the invention thus provide an improved means to produce a preferred type of hydrated molecule beam that does not denature the proteins, and thus can be used in combination with the methods of the first aspect of the invention. As will be apparent to those of skill in the art, the methods of this third aspect are not limited to use in combination with the methods of the first aspect (nor are the methods of the first aspect of the invention limited to use in combination with the third aspect of the invention). These methods of the second aspect can be used for other methods for determining molecular structure of a proteins, as well as methods including, but not limited to spectroscopy of proteins and other molecular species; nanoscale free-form fabrication based on proteins and other molecular species; formation of novel low temperature forms of protein complexes, possible including pharmacological species; deposition of proteins or other molecular species onto substrates for the purpose of fabricating sensor arrays to detect biological or other chemical agents; introduction of proteins or other molecular species into vacuum to serve as targets for bombardment by laser light, x-ray radiation, neutrons, or other energetic beams; introduction of proteins or other molecular species into vacuum for the purpose of controlling or promoting directed, free-space chemical reactions, possibly with nanoscale spatial resolution; introduction of proteins or other molecular species into vacuum for the purpose of separating, analyzing, or purifying these species.

A detailed discussion is provided above for hydrated protein solutions, protein quench-cooling, the formation of vitreous ice droplets, and liquid flow into vacuum. Each such embodiment for the first aspect of the invention is applicable in this third aspect of the invention as well.

### EXAMPLE 1

### Diffraction and Imaging from a Beam of Laser-Aligned Proteins: Resolution Limits

Abstract.

We consider the effect of the limited alignment of hydrated molecules, in a laser-aligned molecular beam, on diffraction patterns taken from the beam. Simulated patterns for a protein beam are inverted using the Fienup-Gerchberg-Saxton phasing algorithm, and the effect of limited alignment on the resolution of the resulting potential maps is studied. For a typical protein molecule (lysozyme) with anisotropic polarizability, it is found that up to 1 kW of continuous-wave near-infrared laser power (depending on dielectric constant), together with cooling to liquid nitrogen temperatures, may be needed to produce sufficiently accurate alignment for direct observation of the secondary structure of proteins in the reconstructed potential or charge-density map. For a typical virus (TMV), a 50 W CW laser is adequate for sub-nanometer resolution at room temperature. The dependence of resolution on laser power, temperature, molecular size, shape and dielectric constant are analyzed.

Introduction

In a recent publication (Spence and Doak 2004), the use of diffraction patterns from aligned molecular beams has been proposed as an approach to the structure determination of proteins which are difficult to crystallize. As in previous work on small organic molecules (Stapelfeldt and Seideman 2003), such as amino acids (Lindinger, Toennies and Vilesov 1999) polarized laser light is used to align the molecules in the beam. By cooling a beam of hydrated proteins to low temperature, sufficient alignment for diffraction purposes might be possible. We therefore suggest an arrangement consisting of continuous, orthogonal, intersecting electron (or X-ray), molecular and laser beams, as shown in FIG. 1. Surplus vitreous ice surrounding the proteins is allowed to sublimate along the molecular beam flight path. The limited coherence of the electron beam ensures that no interference occurs between the wavefields scattered by different molecules within the electron beam. Thus the diffraction pattern is a sum of the intensities of the identical patterns from the many hydrated molecules within the beam at any one time. The two-dimensional electron diffraction pattern accumulates continuously at the detector for a fixed laser and molecular orientation, before being read out. Repeating this process for many new orientations (each with a new laser polarization direction) would allow a tomographic reconstruction of the molecular charge density or electrostatic potential. Since the oriented molecules traversing the 10 micron beam (in 200 ns) are constantly replenished, radiation damage at atomic resolution can be shown to be negligible. In steady state, the oriented molecular arrangement within the beam acts like a stationary nanocrystal in determining the exposure time. (This time is estimated to be about 80 seconds per orientation for electron diffraction. By using a “shower-head” array of nozzles to compensate for the lower scattering cross section of X-rays, a similar exposure time could be obtained using a medium-energy synchrotron undulator).

This arrangement would result in great simplification and reduction of data collection times over similar femtosecond pulsed X-ray schemes which have been proposed (Neutze, Wouts, Spoel, Weckert and Hadju 2000). These are based on the finding from simulations that the onset of radiation damage at atomic resolution occurs about 10-20 femtoseconds after significant diffraction has occurred. The method aims to collect patterns from successive randomly oriented proteins in a stream crossing an X-ray beam in synchrony with the X-ray pulses. The need for area-detector read-out (a slow process) after recording the diffraction pattern from each molecule in that method is eliminated in our method, as is the need to determine the orientation between successive patterns from randomly oriented molecules. By comparison with existing cryo-electron microscopy methods, this approach could greatly improve throughput while avoiding tedious sample preparation, and may be able to handle smaller molecules at higher resolution. Since both methods deal with proteins in vitreous ice, they will be affected equally by conformational variations, which might be minimized by attaching a small molecule to the proteins. By comparison with NMR, the new method, if successful, would offer much faster throughput since the molecular beam is fed from a solution of proteins in room-temperature water to which cryoprotectant is added to encourage vitrification. This solution enters a vacuum chamber through a micron-sized aperture, where necking, droplet-formation and freezing occurs to produce a stream of vitreous iceballs containing proteins, as in similar previous work (Bartell and Huang 1994, Charvat et al 2002). In this paper we investigate in more detail the degree of alignment possible in laser-aligned molecular beams at low temperature for the case of large molecules, and determine the limits thus imposed on the resolution of reconstructed charge density maps. The phase problem for the continuous distribution of scattering from individual molecules is solved using recently developed iterative methods, which have now been applied to both X-ray (Miao, Charalambous, Kirz and Sayre 1999; Marchesini, He, Chapman, Hau-Riege, Noy, Howells, Weierstall and Spence 2003) and electron diffraction data (Weierstall, Chen, Spence, Howells, Isaacson and Panepucci 2001), most recently at atomic resolution (Zuo, Vartanyants, Gao, Zhang and Nagahara 2003).

The aim of this work is to determine the experimental conditions (laser power, temperature, etc.) which would allow the observation of the secondary structure of proteins, by applying the iterative inversion algorithm to simulated diffraction patterns with various degrees of misalignment.

2. Laser Alignment.

Detailed quantum-mechanical treatments of the laser alignment problem for small-molecule beams have appeared in the literature (Friedrich and Herschbach 1995; Stapelfeldt and Seideman 2003), including the case where elliptical polarization is used to provide “three-dimensional” orientation (see later discussion). Here we first describe the simplest classical model of one-dimensional alignment for a large molecule with axial symmetry, which exposes the dependence of the effect on experimental parameters. This is then used to determine the resolution limits for a given degree of alignment. Detailed calculations of the anisotropic, frequency-dependant, electronic molecular polarizability for small molecules, on which the alignment effect depends, have been reported elsewhere (Fraschini, Bonati and Pitea 1996). (We assume, as in the small-molecule work, that resonances due to nuclear vibrations, as studied in infrared absorption spectroscopy, are avoided). In the adiabatic approximation, and away from such resonances, the orientation energy of a molecule within a polarized light field due to a difference in induced electronic polarizability Δα=α□□−α□□ along principle axes is (Seideman, 2001)

$$H = - \frac{1}{4} {\sum }_{ρ , {ρ}^{′}}^{} {E}_{ρ} {α}_{ρ , {ρ}^{′}} {E}_{{ρ}^{′}} = - \frac{2 π I}{c} Δα {cos}^{2} ( θ ) \qquad 1$$

where I is the laser power density (intensity), c the speed of light and θ the polar Euler angle between the symmetry axis of the molecule and the electric field vector E of the laser, here taken to be plane-polarized. Only the frequency-dependant electronic contribution to Δα, and the RMS value of the electric field, is effective—the time average of the linear (Stark) term which depends on permanent dipole moment is zero. Setting this potential energy H equal to thermal energy (½)kT by equipartition, we obtain, in the harmonic approximation, an RMS angular variation of

$$〈 Δ {ϑ}^{2} 〉 = \frac{T}{3 \times {10}^{- 8} I Δα} \qquad 2$$

where I is the laser power density (intensity) in W/cm² and Δα is given in nm³. The same result is obtained in this limit by evaluating the expectation value of the thermal average of cos²(θ) , with Boltzman-factor weighting, as given previously for quantum systems (Seideman 2001). Since Δα is proportional to molecular volume, the tolerable misalignment decreases steeply as the inverse cube of the molecular dimension, inversely as the degree of anisotropy and laser intensity, and is proportional to the temperature.

Accurate estimates of the anisotropic frequency-dependant electronic polarizability tensor α for proteins are difficult to obtain, particularly in the near-infrared (NIR) region around 1000 nm wavelength where powerful continuous wave (CW) lasers are available. Calculations for amino acids have recently been published (Song 2002). Experimental vibrational near-infrared spectroscopy of small organic molecules shows the dramatic reduction in density of third-harmonic absorption lines due to nuclear motion around one micron wavelength as temperature is reduced to 15 K (Boraas, Lin and Reilly 1994), while optical spectra for proteins appear to be featureless in this spectral region (Arakawa et al 1997). Well away from resonances, the better known zero-frequency values of electronic polarizability may be used. A considerable literature exists on modeling dielectric properties of proteins (Porschke 1997). Here we model a large molecule as a dielectric prolate spheroid of volume V and ellipticity 0.8, for which the polarizability may be evaluated exactly by the methods of classical electrostatics in terms of the dielectric constant K (Bohren and Huffman 1983). We take K =4 for protein (Simonson 2003), giving Δα=γV with typical shape factor γ=0.3. From equation 2 the relation between temperature and laser power then becomes
T=3×10⁻⁸<Δθ²>γV I (W/cm²) 3

We determined plots of temperature against laser power, based on this equation, for a virus, a macromolecular assembly (Ribosome) and a large protein of length 11 nm, all with Δθ fixed at 4°. We determined that, for the laser power density of 2.5×10⁸ W/cm2 (corresponding to a modern 50 Watt fiber laser operating at one micron wavelength, with 5 micron diameter focus), a temperature of only about 230K is needed to sharply align a large macromolecule like the ribosome, while 60K may be needed for the protein. Our first experiments are commencing with phage viruses or TMV, which can be aligned at room temperature in water rather than ice. In fact, much higher near-infrared CW single-mode laser power densities up to 50×10⁸ W/cm² can be obtained from fiber lasers, if all of the output power is focused into a 5 micron diameter spot.

In the simplest approximation, discussed in more detail below, the spatial resolution d to be expected in a charge density map reconstructed from diffraction pattern intensities averaged over a small range Δθ of orientations is d=L Δθ/2=0.7 nm for a molecular length L=20 nm with Δθ=4°. We note that some secondary structure of proteins (e.g. alpha-helices) becomes visible at between 1 nm and 0.7 nm resolution, but higher resolution (perhaps 0.4 nm) is needed to see beta sheets. More accurate estimates of resolution loss with misalignment follow in the next section.

The time taken for a large molecule to align can be roughly estimated from its natural oscillation period and damping time. This can be estimated by modeling the motion as a damped torsion pendulum, with spring constant k given by the second derivative of the energy in equation 1. These are based on Langevin's treatment of Brownian motion, and the galvanometer mirror fluctuation problem (Uhlenbeck and Goudsmit, 1929). The oscillation period 2π(I/k)^{1/2}=13 ns for the ribosome (I is the moment of inertia), while the Stokes damping time is I/(6 πr³ η)=1.8 ns, with η the viscosity of dry nitrogen. (This might be used for medium-energy X-ray experiments at atmospheric pressure). In the low pressure free-molecular-flow regime, allowance must be made for variation of viscosity with pressure, if the mean free path exceeds molecular dimensions. These times should be compared with the transit time of 200 ns for a molecule traveling at 50 m/sec across a 10 micron diameter beam. Thermal fluctuations, given by eqn. 2, remain after the decay of these damped oscillations.

Since the electronic and vibrational polarizabilities are additive, considerable enhancement of the alignment effect can be obtained by operating a tunable laser at a frequency near a vibrational resonance (Friedrich and Herschbach 1995). Anomalous dispersion then enhances both the polarizability and its anisotropy. The treatment above includes only anisotropic molecular shape effects arising from electronic polarizability—the addition of vibrational anisotropy near resonance and an isotropic polarizability tensor will produce alignment forces even for spherical molecules. This enhancement corresponds to multiphonon processes and, for sufficiently high laser power, would result in dissociation of the molecule. We calculate the temperature rise of water during the transit time to be 4 degrees at a laser power of 2.5×10⁸ Watt/cm⁻² and one micron wavelength.

These considerations refer to the alignment of molecules about a single axis using plane-polarized light, or, with elliptically polarized light, to fixing the direction but not the sense of molecular axes. (The energy depends only on E², not the sense of E). Using elliptical polarization the energy H is therefore unchanged by a two-fold rotation about any axis, resulting in four degenerate orientations. Two-dimensional diffraction patterns obtained from a mixture of all these orientations at small diffraction wavelength are subject to the projection approximation (a flat Ewald sphere, in which three-dimensional two-fold symmetries become mirror lines or inversion symmetry when projected onto two dimensions) and inversion symmetry (Friedel's law). For a molecule without symmetry, the combination of all these operations produces patterns of mm symmetry from an equal population of all four equivalent molecular orientations. Several methods have been proposed to fix molecular orientation absolutely, one of which has recently been tested (Sakai et al 2003). Here the Stark linear term in the Hamiltonian, sensitive to any permanent dipole moment (but with zero time average for alternating fields), is used by the addition of a static field to the experiment whose sense determines the molecular orientation. Alternatively, a fractional-cycle laser pulse which does not change sign might be used (Seideman, 2004).

The effects of recoil due to the momentum transfer associated with diffraction have been considered. In the worst case where all recoil appears as angular momentum it may be shown that the rotation angle in the interval between electron arrivals is less than 0.01 degrees at an electron beam current of one microamp, producing random orientational fluctuations of this magnitude which are well beyond the spatial resolution of the experiment.

As discussed in our earlier paper (Spence and Doak 2004) each aspect of this proposal has been demonstrated experimentally in the literature, except the extension to large molecules. (See, for example, measurement of degree of laser-alignment for small molecules (Stapelfedlt and Seideman 2003), electron diffraction from a beam of iceballs (Bartell 1994 ), electron diffraction from laser-aligned molecules (Hoshina et al 2003), and inversion of an electron diffraction pattern from one nanotube to an atomic-resolution image by iterative solution of the phase problem (Zuo et al, 2003). The practically of the method depends on the recent development of very high power CW fiber lasers, and on the favorable dependence of the alignment error on the inverse cube of the molecular dimension.

3. Resolution Limits Due to Misalignment.

In this section we present simulated continuous diffraction patterns for a small organic molecule (in two dimensions) and a protein (in three). The intensity of these patterns is summed over a small angular range of orientations, and the results used as the input to a phasing program based on the Fienup-Gerchberg-Saxton HiO algorithm. This solves the phase problem, allowing the molecular potential to be recovered, whose resolution is examined for various degrees of misalignment. The phasing algorithm assumes that the complex scattering distribution is the Fraunhoffer far-field diffraction pattern of the electrostatic potential of the molecule, to which it is related by simple Fourier tranform. (Curvature of the Ewald sphere and multiple scattering are neglected). The algorithm iterates between real and reciprocal space, imposing known constraints in each domain. Initially we treat a simple two-dimensional projection of a molecule with orientational error due only to rotation about the projection axis. For the case of the three-dimenensional lysozyme molecule, the diffraction data is first assembled into a three-dimensional reciprocal-space volume, and the iterations are based on three-dimensional Fourier Transformation. In our case the constraints are the measured Fourier moduli and the known sign of the scattering potential; Note that the misoriented diffraction data is inconsistent (especially at high angles) with the true potential we are trying to reconstruct. The approximate boundary of the molecule (its support function) is also a powerful convex constraint, and it has recently been shown that this can be obtained iteratively from the known autocorrelation function of the molecule (Marchesini et al. 2003), or by using a modification of the Ozlanyi-Suto flipping algorithm (Oszlanyi and Suto 2004). Having reconstructed the potential from the phased (complex) diffraction pattern, we then estimate the resolution in the potential map, and plot it as a function of increasing misalignment. We determined the electrostatic potential for copper phthalocyanine (CuPhTh), and the corresponding “oversampled” diffraction pattern. (The sampling interval is optimal for the scattered intensity according Shannon's theorem: it is half the Bragg angle for scattering from a periodically repeated molecule (Marchesini et al 2003) ). For comparison, we determined a misaligned pattern obtained from many diffraction patterns summed over a Gaussian distribution of orientations with 5° standard deviation. The patterns were rotated slightly about the c axis (parallel to the electron beam), and no other rotations are considered for this first simplified arrangement.

While diffraction patterns from misaligned molecules may contain very high resolution (high angle) scattering, not all of this is meaningful, since the resulting retrieved potential will not faithfully represent the molecule. (The HIO algorithm finds the best potential consistent with the misaligned diffraction data and other constraints. “Best” is defined by the minimum Euclidean distance ε in Hilbert space between suitably constrained sets, where ε is the HIO error metric). Because of its popularity in crystallography, we show the crystallographic R-factor

$$R ( {u}_{o} ) = \frac{{\sum }_{g < {u}_{o}} \vert \vert {F}_{g}^{e} \vert - \vert {F}_{g}^{m} \vert \vert}{{\sum }_{g < {u}_{o}} \vert {F}_{g}^{m} \vert} \qquad ( 4$$

where the sum extends to a given resolution limit d=1/uₒ. |F^{e}_{g}| are the measured moduli of the (misaligned) Fourier coefficients used in the HIO algorithm, while |F^{m}_{g}| are the true values from the known structure. R takes no account of the phases of the Fourier coefficients, and may be related uniquely to structure only if atomicity is assumed. Experience from protein crystallography suggests that an R-factor of about 0.2 is the maximum acceptable value, however we choose R=0.15 as our condition for fidelity. We therefore wish to find the largest misalignment possible which gives the resolution d=0.8 nm needed to see secondary protein structure, subject to the constraint R<0.15.

In order for alignment based on shape anisotropy to be possible, a molecule must have an elongated shape. (Other sources of anisotropy are also possible, as mentioned above). Such a molecule will oscillate about its center of mass. If the long axis has length L, then, for single axis alignment, atoms at the end of a spheroidal molecule move through the largest distance during oscillation of d=Δθ′L/2, where Δθ1s the full angular range of motion and d may be considered the average resolution (smearing). (This is consistent with the idea that smearing due to misalignment, which increases radially in reciprocal space, does not limit resolution if it occurs over distances smaller than the width of the shape transform). Then Δθ may be associated with the standard deviation <Δθ²>^{1/2} from equation 2. However this expression for d depends on the dimensionality of the alignment, and the shape of the molecule, since shape affects the number of atoms undergoing the largest motions, and most atoms move by a smaller amount. We therefore define d=k ΔθL, where 0.5<k<1, and use simulations to find the value of k for simple cases. An analogy with the Debye-Waller factor for crystals can be made, however while uncorrelated molecular rotations in crystals may affect the temperature factor (Pauling, 1930), in our case, with the beam coherence width comparable to one molecule and no interference between different molecules (as occurs in crystals), the azmithal smearing of our two-dimensional diffraction pattern about the normal to the pattern does not affect the (radial) temperature factor, but does affect image resolution through its influence on phases.

We plotted the R-factor against resolution d for several misalignment angles of CuPhTh diffraction patterns. The resolution d has been limited by terminating the diffraction pattern at scattering angle θ=λ/d. The region below the horizontal line indicates the domain in which faithful reconstructions (R<0.15) can be obtained with sufficient (or better) resolution than that needed to see secondary structure (d<1 nm) in a protein. Note that the shape of these curves will depend on any a-priori information, such as convex or non-convex constraints used in the phasing algorithm. For proteins, this might (but did not) include knowledge of the protein sequence, the known “grey-level” histogram constraint for the potential (often taken to be the same for all proteins), an atomicity constraint, or any of the standard density modification constraints used in crystallography (Rossmann, 2001).

Taking values of misalignment along R=0.15, we obtained a plot showing resolution d against misalignment angle Δθ for a faithful reconstruction. We determined that, if additional constraints are not used, the maximum misalignment which can be tolerated for 0.2 nm resolution for this small molecule is about eight degrees. We also considered our simple intuitive expression d=k L Δθ, relating resolution to misalignment. This was plotted as a straight line and is a good fit with k=0.7 and R=0.15. The achievement of seven-degree misalignment for such a small molecule would require lower temperature and/or higher laser power than that shown for the molecules discussed above.

Reconstructed images from 5 and 9-degree misaligned diffraction patterns at several resolutions were obtained. An interpretable image can be reconstructed at 5° and 2 Å resolution, whereas there are many erroneous peaks in the image at higher (1 Å) resolution. Reconstructed 9-degree misaligned image, at resolutions of 3 Å and 2 Å, respectively, were also determined. Similarly, whereas the 3 Å image is correct, the 2 Å image is incorrect. This indicates the importance of using both a goodness of fit index such as R together with the resolution parameter (the angular cutoff in the diffraction data used as input for HIO).

We also determined the projected potential along the [001] direction for a simple protein, lysozyme (5LYZ), with coordinates taken from the Protein Data Base (Tetragonal, P 43 21 2 (#96), cell constants a=79.1 Å, b=79.1 Å, c=37.9 Å, 8008 atoms). The diffraction pattern obtained was calculated for an isolated molecule within a super-cell, whereas the crystal contains eight molecules per cell. To provide about 2-times oversampling, we used a larger unit cell which is 1.2 time bigger than the original one: a=94.9 Å, b=94.9 Å, c=45.5 Å. A single 5LYZ molecule, which has 1102 non-hydrogen atoms, was placed in the center of the larger cell. We assume elliptically polarized light, with the major axis of the ellipse parallel to the electron beam and to the c axis of the molecule. However, for simplicity, no rotation about this axis is considered. (This would produce effects similar to those seen in the case of CuPhTh above). The molecular c axis is assumed to fall within a solid angle centered on c. The tilt angle is represented by three Euler angles, φ, θ and ψ. The three Euler angles are defined with respect to a coordinate origin at the center of the mass of the molecule, which is assumed to remain stationary as the molecule tilts around. The three Euler angles are defined with respect to a coordinate origin at the center of mass of the molecule, which is assumed to remain stationary as the molecule tilts around. (The z axis lies in the electron beam direction, which coincides with the long axis of the protein molecule when the tilt error is zero. x and y lie in the plane normal to the z axis, forming a right-handed coordinate system. φ is the first rotation angle around the z axis, the second rotation θ is the angle about the x axis, and the third rotation φ is about the z′ axis. (A rotation of the z axis by θ about the x axis generates the z′ axis). This convention can be found at http://mathworld.wolfram.com/). Since a single 5LYZ molecule loses the symmetry it has in the crystal, φ ranges from 0 to 360 degree, and θ from the largest negative misaligned angle to the largest positive misalignment angle (e.g from −5° to 5°). In addition, ψ=−φ, since we do not consider rotation around the electron beam direction. A simulated diffraction pattern projected along [001] was determined, taken from molecules whose largest misalignment angle is Δθ=5 degrees. (The alignment angles were uniformly distributed about the beam axis, which is also the c axis of the molecule. The misalignment solid angle was ΔΩ=λΔθ^{□}=0.02 str.) The three-dimensional Fourier iterations were performed using a 97×97×47 voxel array, which took 2 seconds per iteration on a 2.6 Ghz pc. and required about 60 iterations to converge. A charge-flipping variant of the HIO algorithm was used, which has been shown to correspond to Fienup's output-output algorithm (Wu, Weierstall, Spence and Koch, 2004). This algorithm uses a density threshold to find the support (Ozlanyi and Suto, 2004).

We determined a plot of R (equation 4) against resolution d for several misalignment angles for the 5LYZ molecule. Again, we set R=0.15 as the threshold. A plot of resolution against misalignment angle was also determined. (The best-fit value of k=l is expected to be an overestimate because a uniform distribution of angles was used). From the curve, we find that if the largest misaligned angle is 5 degree, a faithful structural image can be obtained at 6 Å resolution. Reconstructed images were obtained at 6 Å and 1.4 Å. The 1.4 A potential map has lost considerable information.

The introduction of noise influences the phase recovery process mainly by causing the algorithm to stagnate, rather than by limiting resolution, however prior to stagnation resolution loss (as defined above) does occur. This process has been investigated both theoretically (Fienup (1997)) and in experimental reconstructions of non-periodic images from both electron (Zuo et al 2003) and X-ray (Marchesini et al 2003) data. For these protein images, we have simulated the effect of noise using a parameter noise=(signal/SNR)=random where SNR is the signal-to-noise ratio and random is a random number from −0.5 to 0.5 (Miao et al., 1998). The noise modulated by the parameter SNR was added to simulated diffraction patterns of copper phthalocyanine, taken from molecules whose largest misalignment angle is Δθ=5 degrees. The influence of the noise on resolution was determined, calculated using the same method described above. (We use a crystallographic R-factor for data falling within a certain resolution circle in the diffraction pattern, and an acceptance threshold of R=0.15). Similar noise was also added to the pattern from a lysozyme molecule with the largest misalignment angle of 5 degrees. A plot of resolution against SNR is shown was also determined for lysozyme. In both cases, we found that successful inversion required a SNR value greater than 10.

4. Discussion.

For a large macro-molecular assembly such as the Ribosome, with k=0.5, and L=35 nm, a misalignment of less than 3.2° is required for 1 nm resolution. This requires a temperature a little below 230K for a 50 Watt CW laser with 5 micron focus. For the TMV virus modeled more accurately as a prolate spheroid with radii a=150nm, b=10 nm, the resulting eccentricity is e=0.9977, giving a shape factor in the polarizability calculation (Bohren and Huffinan, 1983) of γ=10 for equation 3. For such a rod of length L=300nm oscillating about its center of mass, the resolution may be taken as ΔθL/2, so that a misalignment Δθ=0.380°=[<Δθ²>]^{1/2} is needed for 1 nm resolution. Equation 3 then indicates that a temperature of 320K is required to achieve this with the same laser conditions. (The pitch of the TMV helix is 2.3 nm and could be resolved under these conditions). We note that this temperature is above the freezing point of water, so that diffraction from TMV in water droplets may be possible.

For smaller proteins, lower temperatures or higher laser powers will be needed. For example, Lysozyme may be modeled as a prolate spheroid with radii a=2.25 nm, b=1.3 nm, giving eccentricity e=0.8 and γ=0.3 if a dielectric constant of 15 is used for hydrated material. Then a temperature of 20°K is needed to achieve 0.7 nm resolution using a 50W CW NIR laser. This falls to 6°K if the dielectric constant is reduced to 4. Similar fiber lasers are now commercially available at powers up to 1 kW. At 1 kW, with a dielectric constant of 15, this resolution for Lysozyme can be achieved at 366°K, above room temperature ( or at 115K for a dielectric constant of 4).

In general, for an oblate spheroid of radii a>b , combining d=a Δθ with equation 3, we find the resolution d to be

$$d = {( \frac{1}{b} ) [ \frac{3 a T}{3 \times {10}^{8} I 4 πγ} ]}^{1 / 2}$$

where a,b, and d are expressed in nm and I in Watt/cm². For a given laser power, temperature, and aspect ratio a/b, the resolution improves (d decreases) inversely as the square root of the molecular size.

It would appear that data analysis could best be undertaken in two stages. At first, the HIO algorithm, which does not assume atomicity and require atomic-resolution data, is used to locate the main alpha-helices. These act as a framework for the structure and define much of the fold. Then an attempt to further refine the data could be made using the methods of powder diffraction, in which a model structure is parameterized in terms of atom positions, and the parameters varied for best fit to the diffraction data in the manner of a Reitveld refinement. The procedure will nevertheless be limited by the resolution and noise present in the data. A protein structure has been solved successfully using powder data for the first time recently in the case where the structure of a related transformed structure was known (Von Dreele, Stephens, Smith and Blessing 2000).

Proteins labeled with a heavy atom such as selenium might also be used to further improve the phasing process. The anisotropy of the protein can also be increased by the addition of other molecules to the protein (Glaeser 2004). We will consider this approach, and the possibility of angular deconvolution, in a subsequent paper. Deconvolution could be used to measure the alignment of the molecules, and to enhance the resolution of the image inversion. We note the improved angular resolution of fiber diffraction data (corresponding to our single axis alignment) over power diffraction data.

For certain structures, simplifications arise due to symmetry. For example, for the simplest helical structures, the diffracted intensity may be independent or only weakly dependant on rotation about the primary axis, so that single-axis alignment may suffice. The methods of fibre diffraction may be useful. In addition, further constraints may be applied in particular cases. It is now known that 80% of alpha-helices in membrane proteins can be predicted from the sequence alone, and this information might be incorporated into a histogram constraint. These alpha-helices constitute 50% of globular proteins. We have also considered the use of small crystallites of protein, containing, say n³ molecules in each crystallite. Since there is coherence across the entire crystallite, the scattered intensity for n=3, for example, would be increased by 27²=729 times if the data collection is not angle-resolved, as in electron diffraction. However the formation of these crystallites in solution, with identical n for each crystallite, may be very difficult. Our first experiments are about to start using virus particles, with high n-fold symmetry, giving such an intensity advantage, in addition to the possibility of accurate alignment at room temperature due to their large volume.

In summary we find that sub-nanometer resolution in diffraction patterns from a laser-aligned molecular beam of small proteins at liquid nitrogen temperature will require kilowatt CW laser power in the infrared, whereas tens of watts are needed for large macromolecular assemblies and viruses. The conditions of power and temperature depend strongly on the molecular size, shape and (poorly known) dielectric constant, but most importantly on size.

### REFERENCES FOR EXAMPLE 1

Arakawa, E. P. Tuminello, B.Khare, M.Milham.(1997) Biospect. 3, 73.
Bartell, L.S. and J. Huang. (1994) J. Phys Chem. 98, 7455.
Bohren, C. E. and Huffinan, D. R. Absorption and scattering of light by small particles. Wiley. New York. (1983).
Boraas, K. and Z. Lin (1994). J. Chem Phys. 100, 7916.
Charvat, A., E. Lugovoj, M.Faubel, B.Abel.(2002) Eur. Phys. J D20, 573
Fienup, J. (1997). Applied Optics 36, 8352.
Fraschini, E., L. Bonati, D. Pitea (1996). J. Phys Chem 100, 10564.
Friedrich, B. and D. Herschbach (1995). J. Chem Phys. 99, 15686.
Glaeser, R. (2004). Personal communication. Hosh
ina, K. K. Yamanouchi, T. Ohshima, Y. Ose, H. Todokoro. (2003) J. Chem Phys. 118, 6211
Kappel, E. (1939) Naturwiss. 666 (1939).
Lindinger, A., J. P. Toennies, A.F. Vilesov (1999). J. Chem. Phys. 110, 1429.
Marchesini, S., H. He, H.Chapman, S. Hau-Riege, A. Noy, M. Howells, U. Weierstall, J. Spence (2003). Phys Rev B68, 140101 (R).
Miao, J., C. Charalambous, J. Kirz, D. Sayre (1999). Nature 400, 342.
Miao, J., Sayre, D. & Chapman, H. N. (1998). J. Opt. Soc. Am. A15, 1662-1669.
Rossmann, M. ed. (2001). International Tables for crystallography. Volume F. Dordrecht/Reidel/Kluwer, Boston. F15.1: p.311.
Neutze, R., R. Wouts, T. van der Spoel, E. Weckert, J. Hadju (2000). Nature 406, 752.
Oszlanyi, G. and A. Suto (2004). Acta Cryst. A60, 134.
Pauling, L. (1930) Phys. Rev. 36, p. 430
Porschke, D. (1997). Biophysical Journal 66, 241.
Sakai, H., S. Minemoto, H. Nanjo, H. Tanji, T. Suzuki.(2003) Phys Rev Letts. 90, 083001
Seideman, T. (2001) J. Chem Phys., 115, 5965.
Siedeman, T. (2004) Personal communication.
Simonson, T. (2003). Rep Prog Phys 66, 737.
Song, X. (2002). J. Chem Phys. 116, 9359.
Spence, J. and B. Doak (2004). Physical Review Letters 92, 198102.
Spence, J., U.Weierstall, T. Fricke, R.Glaeser, K. Downing. (2003). J. Struct. Biol., 144, p.209.
Stapelfeldt, H. and Seideman, T. (2003). Rev. Mod. Phys. 75, 543.
Von Dreele, R. B., P. Stephens, G. Smith, R. Blessing (2000). Acta Cryst. D56, 1549.
Uhlenbeck, G.E. and Goudsmit, S. (1929) Phys. Rev. 34, 145
Weierstall, U., Q. Chen, J.Spence, M. Howells, M.Isaacson, R. Panepucci (2001). Ultramic. 90, 171.

Wu, J.S., Weierstall, U. Spence, J. C. H. and Koch, C. T. (2004) Optics Letters. 29, 2737.
Zuo, J. M., I. A. Vartanyants, et al. (2003). Science 300, 1419.

### EXAMPLE 2

### Damped and Thermal Motion of Laser-Aligned Hydrated Macromolecules for Diffraction

Abstract

We consider a monodispersed Rayleigh droplet beam of water droplets doped with proteins. An intense infrared laser is used to align these droplets. The arrangement has been proposed for electron and X-ray diffraction studies of proteins which are difficult to crystallize. This paper considers the effect of thermal fluctuations on the angular spread of alignment in thermal equilibrium, and relaxation phenomena, particularly the damping of oscillations excited as the molecules enter the field. The possibility of adiabatic alignment is also considered. We find that damping times in a high pressure gas cell as used in X-ray diffraction experiments are short compared to the time taken for molecules to traverse the beam, and that a suitably shaped field might be used for electron diffraction experiments in vacuum to provide adiabatic alignment, thus obviating the need for a damping gas cell.

Introduction

We have proposed the use of a laser-aligned beam of hydrated proteins for protein crystallography, a method we may call Serial Crystallography. The method builds on much earlier experimental work on beams of droplets containing molecules³ and on the laser-alignment of beams of small molecules⁴. Electron diffraction patterns have been obtained from a steady stream of sub-micron iceballs⁵, and suitable doped droplet beams are now operating in our laboratory. (These operate on similar principles to the ink-jet printer). In our previous work², we discussed in detail the effect of equilibrium thermal fluctuations on alignment, and on the reconstruction of charge-density maps of large molecules from diffraction patterns obtained from such a stream of partially-aligned molecules. Here we will concentrate on dynamic effects such as “overshoot” of the molecular orientation as it enters the laser field , on damping of this field-induced oscillation in a gas cell, and on the possibility of adiabatic field switch-on as a means to improve the molecular alignment and thereby the resolution of the diffraction patterns.

Almost all of our knowledge of molecular structure in structural biology comes from protein crystallography. Protein crystallography succeeds because protein crystallization forces identical molecules into strict alignment. This both concentrates X-rays into easily detected Bragg beams, and divides the radiation dose over a very large number of molecules, each of which then receives a small enough dose to avoid damage at the level (resolution) of interest. But there is a large group of proteins, including the important class of membrane proteins, which are difficult to crystallize. Only 83 of the thousands of membrane proteins, crucial for drug delivery, have been crystallized and solved, while many proteins can probably never be crystallized. Our Serial Crystallography method is designed to address all these issues. In brief, a beam of droplets containing individual molecules is passed across a laser beam whose strong electric field aligns the molecules. Intersecting both these beams at right angles is a synchrotron X-ray beam (or a high-energy electron beam), from which a diffraction pattern is accumulated. The intersection volume is about ten microns across, so that many molecules lie within it at any instant, contributing simultaneously to the diffraction pattern. The coherence conditions in the X-ray beam are arranged so that there is no interference between different molecules, which would produce speckle at the detector. After readout of this pattern, the orientation of the molecules is changed by rotating the laser polarization. A three-dimensional charge density map can then be reconstructed from the diffraction patterns following solution of the phase problem, using new iterative phase retrieval algorithms⁶.

This paper analyses the motion of large macro-molecules such as proteins passing through the field of such an intense non-resonant near-infrared laser. We assume that surplus water surrounding the molecules is evaporated, followed by evaporative cooling, leaving a very thin vitreous ice straight-jacket surrounding the molecule (see references in previous work^{2 3} for details of frozen droplet beam formation). We are especially interested here in the thermal fluctuations and damped oscillations of the motion for a single-file stream of molecules traveling at about 50 m/sec at low rotational temperature. The resolution of the resulting reconstructed charge-density map has been shown to depend critically on these fluctuations and damping effects.² The resolution is directly proportional to the angle of alignment. Our aim is to resolve the secondary folding structure of proteins, which requires a resolution of about 0.7 nm. In this paper, we treat the simplest case of a rotator, in which the molecule is considered to have two equal moments of inertia Iₓ=I_{y}=I; I_{z}=0, so that the angular momentum about its long (z)-axis may be neglected. Also, we assume that the dielectric polarizability of the molecule has uniaxial anisotropy with the easy axis coinciding with the mechanical long axis. The effect of deviations from these conditions will be considered in a subsequent paper.

1. Thermal Fluctuations

The direction of protein alignment is defined by the direction of the electric field in the linearly polarized light of the alignment laser, breaking the isotropy of space. As in previous work⁴, we use the induced polarizability anisotropy Aa(K, e) as the source of alignment torque for a protein modeled as a homogeneous prolate dielectric ellipsoid of dielectric constant κ and eccentricity e. Since the minor semiaxes of the molecule under consideration are assumed to be equal, it has a single direction of pronounced anisotropy, and only a one-dimensional alignment is necessary. This can be obtained using a linearly polarized alignment field.⁴ (For molecules without symmetry, three dimensional alignment of the direction (but not sense) of all molecular axes is also possible, using elliptically polarized light, however we do not discuss that case here⁴). The shape anisotropy is the source of the difference in polarizability Δα(κ, e) along two orthogonal axes. In a previous paper2 we gave expressions for Δα, finding that Δα=γ(κ, e ) V, where γ is a dimensionless shape factor and V the protein volume. The energy of the polarizability interaction for one-dimensional alignment is H=−C cos²θ, where C=0.25 E² Δα. Here E is the amplitude of the electric field of the laser, and θ the angle between the long axis of the molecule and the field. If the laser intensity I₀ is measured in Watt/cm² and Δα in nm³, then C=2.1 I₀ Δα×10⁻³¹ Joule.

Since the effects discussed depend strongly on molecular size, we compare a virus (TMV), a macromolecular assembly (the ribosome) and a medium sized protein (Lysozyme). For tobacco mosaic virus (TMV), treated as a prolate spheroid with radii a=300/2 nm and b=17/2 nm, we find Δα (θ=4)=1.72V, while Δα (κ=15) =10V. These values of dielectric constant κ span the range of values for dry and hydrated material⁷. Measured optical constants for horseradish peroxidase protein give κ=2.34 (dry).⁸ For a large macromolecular assembly such as the ribosome, modeled with a=17.5 nm and b=12.5 nm, Δα(κ=4) =0.3V and Δα(κ=15)=0.93 V. For the smaller protein Lysozyme, with a=2.25 nm and b=1.3 nm, Δα(κ=4)=0.5V and Δα(κ=15)=1.6V.

We first justify our classical treatment of the laser alignment of large molecules. The motion of a small molecule with moment of inertia I in an intense laser field is described by the rotational quantum mechanical Hamiltonian⁴ with a potential energy term defined by the field interaction with the induced dipole. The subjects of this paper are much larger and heavier macromolecules. The moment of inertia of the smallest object treated, Lysozyme, is 5×10⁻⁴¹ kg m² (for ribosome and a virus it is 5 and 7 orders of magnitude larger, respectively). The rotational constant B=\overline{h}²/2I, which determines the spacing between rotational energy levels, is 8×10⁻⁶ K for Lysozyme. In the high field limit C>>B, the molecule's states approach those for a harmonic pendulum with energy levels E\overline{h}ω₀ (n+½) and ω₀=\sqrt{2C/I}. Since the energy of thermal fluctuations is large compared to the ground vibrational level (for Lysozyme, kT/\overline{h}ω₀˜1450 at 78 K), the quasi-classical wave packet describing the macromolecule motion Φ∝ exp(iS/\overline{h}), where S is the classical action, has a large phase, and therefore is obliged to follow the classical trajectory. The high-temperature limit of the quantum mechanical averaging of the alignment angle θ (for an intense field) therefore gives a classical result, with the alignment being defined by the temperature and the strength of the polarizability interaction.⁹ For classical behavior, the molecule's angular momentum L˜\sqrt{2IkT} should be much larger than \overline{h}, implying that angular spread due to the uncertainty principle is negligibly small. For the Lysozyme, \sqrt{2IkT}/\overline{h}˜3000 at T=78 K. We can also find the classical turning angle in the interaction potential well, which defines the ultimate resolution possible, as φ=(\overline{h}²/2IC)^{1/4}. In the case of the Lysozyme, this gives φ=1° (0.002° for the TMV), a much finer alignment than that required to obtain a desired resolution of 0.7 nm. Taking into account all these considerations, we may restrict the remaining discussion to the classical limit.

Collisions with gas molecules in the laser beam cause both thermal fluctuations in angular motion, and dissipative damping. In this section we consider only the thermal fluctuations, which persist after damping is complete, and may prevent recording of a sharp diffraction pattern. By analogy with the Langevin theory for partially aligned electrostatic dipoles in a field (extended to the case of induced dipole moments), the thermal average of the degree of misalignment may be written as

$$< {cos}^{2} ( θ ) >= \frac{\int {cos}^{2} ( θ ) exp ( \frac{C {cos}^{2} ( θ )}{k T} ) ⅆ Ω}{\int exp ( \frac{C {cos}^{2} ( θ )}{k T} ) ⅆ Ω} \qquad ( 1 )$$

Here we assume two degrees of freedom (polar and azimuthal angles defining the direction of the molecule's major axis in the lab frame) for one-dimensional alignment along the electric field in the linearly polarized light. We let y=cos(θ), x=C/kT (the ratio of potential to thermal energy) and dΩ=sin θdθdφ. Then

$$〈 {cos}^{2} ( θ ) 〉 = \frac{{\int }_{- 1}^{1} {y}^{2} exp ( x {y}^{2} ) ⅆ y}{{\int }_{- 1}^{1} exp ( x {y}^{2} ) ⅆ y} . \qquad ( 2 )$$

This expression can be re-written in terms of the Dawson integral F(x) =exp(−x²)∫₀^{x} exp(t²)dt as

$$〈 {cos}^{2} ( θ ) 〉 = - \frac{1}{2 x} + \frac{1}{2 \sqrt{x} \cdot F ( \sqrt{x} )} . \qquad ( 2 a )$$

For our experiments we plan to use a 100 Watt CW fiber laser focused to about 10 micron diameter, operating at one micron wavelength in the near infrared, where amino acids show few absorption features. Then I₀=1.3×10⁸ Watt/cm², and taking Δα=0.93V we have C=2.8×10⁻¹⁹ Joule for the ribosome, whose radius is about 17 nm. With T=228 K, a temperature previously measured for an evaporatively cooling droplet stream,⁵ we have a ratio of potential to thermal energy x=90, so that an expansion of Eq. (2a) is needed for large x, where the depth of the angular potential well C greatly exceeds kT, and the angular deviation must therefore be small. Integration by parts gives the asymptotic expansion of the Dawson integral at x□□ in the form F(x)=1/2x+1/(4x³)+3/(8x⁵)+ . . . . After substitution of this result into Eq. (2a) and expansion we obtain, to second order of lx, that
{cos² (θ)}=1−1/x−1/(2x²)− (2b)
so that, for large x, 1−1/x={cos² (θ)}˜1−{θ²}. Therefore, 1/x=kT/C={θ²}, or

$$k T = \frac{1}{4} {E}^{2} Δα 〈 {θ}^{2} 〉 \qquad ( 3 )$$

The result agrees with the equipartition theorem, applied to a harmonic oscillator in two dimensions. This expression, with energy proportional to the square of angular displacement, shows that under these small-angle conditions the molecule executes harmonic oscillations, and the problem is akin to that of the one-dimensional thermal fluctuations of a mirror galvanometer, for which Brownian fluctuations are observed.¹⁰ The period of oscillation is T₀ =2λ/ω₀=2λ\sqrt{I/K}, where I is the moment of inertia and K=2C=4λI₀Δα/c is the spring constant, with c the velocity of light. With x=90 we have {θ²}=1/x or Δθ=6° for the alignment error appropriate to a large macromolecular protein assembly such as the ribosome, using a 100 Watt laser at 228 K. The alignment error \sqrt{{θ²}} varies as the inverse of the square root of the laser power and is proportional to the square root of the temperature.

These small oscillations smear the diffraction patterns during the recording time, which limits the resolution in the reconstructed charge-density map. The rotational smearing also limits the accuracy with which the phase problem can be solved using iterative methods, as analyzed in detail elsewhere.² By combining Eq. (3) with the expression d=\sqrt{{θ²}}·a for the resolution d expected in a reconstructed density map of a prolate spheroidal molecule of length 2a oscillating about its center of mass, we obtain

$$d = \frac{1}{2 π b} \sqrt{\frac{3 kTca}{2 {I}_{0} γ ( κ , e )}} \qquad ( 4 )$$

From Eq. (4) the temperature T and laser intensity I₀ required to obtain a resolution d can be evaluated. The temperature can be plotted against laser intensity for two proteins (Lysozyme and ribosome) and TMV at fixed resolution for two values of the (poorly-known) dielectric constant for each molecule. The volume of a cylinder is used to calculate the differential polarizability for TMV. The resolution chosen for the proteins, d=0.7 nm, is sufficient to resolve the secondary structure of the proteins and to detect the locations of alpha-helices. The operating condition for our 100 W CW fiber laser focused at 10 μm (one micron wavelength) is indicated. It is seen that temperatures below the boiling point of liquid nitrogen are needed for alignment at this laser power. Reducing the waist of this laser to 5 μm results in sufficient TMV alignment at 250 K. Note that higher laser powers are possible −1 kW fiber CW lasers are now available near one micron wavelength. Such a laser would allow efficient alignment for hydrated TMV and ribosome at room temperature.

3. Damping

These thermal fluctuations are superimposed on the initial damped oscillations excited as the molecule first enters the laser field. The switch-on time of this field depends on the spatial distribution of the laser light at its focus. For the anisotropic polarizability interaction only the RMS value of the laser field is effective.¹¹ In section 4 we consider the possibility of adiabatic alignment. Here we apply the classical theory of damped harmonic oscillations to the protein alignment problem in order to determine if, for an abrupt non-adiabatic switch-on, the damping time can be made small compared with the exposure time for each molecule. For a beam traveling at 50 m/sec across an X-ray or electron beam of 10 microns diameter, the transit time is 200 ns.

The relaxation of the molecular orientation to the equilibrium state in an external field is described by the equation of motion

$$I \ddot{θ} + ζ \dot{θ} + \frac{1}{4} {E}^{2} Δα sin ( 2 θ ) = 0 , \qquad ( 5 )$$

which includes the rotational torque ζ\dot{+74} with friction coefficient ζ, expierenced by a rotator in viscous medium (damping of oscillations in liquid droplet or gas cell). In a harmonic approximation this equation is reduced to the standard equation for a damped harmonic oscillator
\ddot{θ}+2λ\dot{θ}+ω₀²θ=0 (6)
with 2π=ζ/I and ω₀=\sqrt{K/I}. For λ<ω₀ (underdamped system), the damping time is
t_{d}=1/□ (7a)
while for an overdamped system with λ>ω₀ the damping time is equal to
t_{d}=1/(λ−\sqrt{λ²−ω₀²}) (7b)

The damping time can be adjusted by passing the molecular beam through a medium with varying viscosity (damping cell). We note in particular that this time is proportional to the viscosity in the overdamped case (where inertia is negligible, as for terminal velocity problems), but is inversely proportional to the viscosity for underdamped systems, where increased viscosity reduces time to equilibrium. Our data shows this behavior for damping time against viscosity, assuming that the rotational friction coefficient depends on viscosity linearly with the same coefficient over the interval of viscosity change. Optimum extinction of oscillations is achieved in the vicinity of conditions for critical damping.

Viscosity is independent of pressure over a wide pressure range, where the mean-free-path l of the gas molecules is small compared to the characteristic macromolecule dimension A, such that l<<A (l˜100 nm for air at STP). In the opposite limit of the molecular free flow (Knudsen) regime, when l>>A, viscosity is a function of pressure. Because in this regime the mean free path is large compared to the protein size, gas molecules scattering on the protein will not perturb the Maxwell velocity distribution in gas. Therefore, the frictional torque, experienced by a macromolecule, can be easily calculated by integrating over its surface the moment of momentum transferred to the macromolecule by impinging and scattered gas molecules. We performed this integration in the linear approximation for a cylinder with circular base, approximating a TMV molecule, and for a sphere to model frictional torque experienced by Lysozyme and ribosome. For a cylinder, the rotational friction coefficient is

$$ζ = \frac{π}{32} mn \overline{v} d {L}^{3} \cdot s + \frac{π}{24} mn \overline{v} d {L}^{3} \cdot ( 1 - s ) , \qquad ( 8 a )$$

where d is the cylinder diameter, L its length, m the mass of a gas molecule, and n the gas molecules concentration. The average velocity of the gas molecules is \overline{v}=\sqrt{8kT/λm}. Finally, s denotes the fraction of gas molecules, which undergo diffuse scattering, and (1−s) is a fraction of molecules, experiencing specular scattering. This expression can be compared with that for the rotational friction coefficient in the case of a rod with a square base (specular reflection s.=0):

$$ζ = \frac{1}{6} mn \overline{v} b {L}^{3} , \qquad ( 8 b )$$

where b is the square side, and L the rod length. Equation (8b) immediately follows from the treatment of Brownian motion for a flat disk in the Knudsen regime given by Uhlenbeck and Goudsmidt.¹⁰ For a sphere we have the result, first obtained by Epstein¹²

$$ζ = \frac{2 π}{3} mn \overline{v} {R}^{4} \cdot s , \qquad ( 8 c )$$

where R is the radius of the sphere. In all these cases, rotational torque due to friction is proportional to gas pressure.

In a liquid and a dense gas with A>>I the frictional torque experienced by a rod-like particle is¹³

$$ζ = \frac{8 π η {a}^{3}}{3 ( ln \frac{2 a}{b} - γ )} . \qquad ( 9 a )$$

Here a is the particle half-length, b the half-width, η the viscosity of the liquid, and

$$γ = 1.57 - 7 \cdot {( {ln}^{- 1} \frac{2 a}{b} - 0.28 )}^{2} .$$

If the particle is approximated by a prolate spheroid with a>>b, then γ=0.5.¹⁴ Finally, the simple Stokes expression
ζ=8ληα³ (9b)
can be used for a sphere.

We wish to determine the conditions of pressure and viscosity needed to ensure that the damping times are much less than the transit time for a non-adiabatic entry of the proteins into the laser field. Table 1 summarizes calculated values of the damping constant 2λ/λ for TMV, ribosome and Lysozyme in water and dry nitrogen, the latter for the free molecular regime and dense gas, using Eqs. (8) and (9). The experimental values for the damping constant in water for TMV and Lysozyme are also given. They are extracted from the diffusivity data¹⁵ using the Einstein relationship between rotational diffusion D and friction coefficient ζD=kT. These values for the damping constant should be compared with the period of free oscillation of the molecules in the electric field of a 100 W laser focused at 10 μm diameter. We see that the motion is always strongly overdamped in water, preventing satisfactory alignment of a molecule rotating inside a water droplet, during the transit time through the laser beam, since there is insufficient time for the alignment to occur within the allowed 200 ns. Using Eq. (7b), we find that the damping times in water are 374 ns for TMV, 124 ns for ribosome, and 72 ns for Lysozyme, all of which are too large for the transit time of 200 ns. Therefore, slower droplets (˜5 m/s) must be used to provide alignment in water. By contrast, the oscillations are underdamped in rarified gas, again resulting in large damping times of 414 ns, 620 ns, and 67 ns at 104 Pa for TMV, ribosome, and Lysozyme, respectively. However, increasing the pressure in a gas damping cell to 10-50 bar allows the transition from strongly underdamped oscillations to nearly critical damping, which is optimal for the alignment of a molecule within a thin ice jacket, rotating as a solid object. When condition for critical damping is satisfied, the relaxation times are 3.7 ns, 1.8 ns, and 0.14 ns for TMV, ribosome, and Lysozyme, respectively. These values are small compared to the transit time through the laser beam.

All three damping regimes were plotted, and the damping behavior of TMV in a gas cell at two pressures of 10⁴ and 10⁶ Pa (possible for a medium or hard X-ray diffraction experiment) with that of TMV in liquid water droplets was compared. The curves awee produced by numerical integration of Eq. (5) with parameters from Table 1, using the fourth-order Runge-Kutta method. We found that damping times in water are prohibitively long compared to the transit time at the droplet velocity of 50 m/s. One should note, however, that provided there is no time limitation as in our case, alignment in liquid can still be achieved in (quasi-) static regime. It is interesting that experiments were successful in aligning TMV in water in a static electric field as early as 1950.16 Recently the possibility of controlling the motion of large rodlike particles (3.8 μm long glass nanorod) by applying light torque (the “laser wrench”) has been demonstrated.¹⁷ Well above atmospheric pressure, the possibility of critical damping is predicted.

4. Adiabatic Conditions

If the rise-time of the laser intensity experienced by the passing molecule is sufficiently slow, the initial overshoot of the molecular motion will be reduced, and gas damping may not be needed. In this section we investigate the possibility of obtaining this desirable adiabatic condition. In an open system with a slowly-varying characteristic parameter (laser intensity in this case) the area enclosed by a system trajectory in phase space is an adiabatic invariant.¹⁸ For a harmonic oscillator with time dependent spring constant K=K(t) the conserved quantity is E(t)/ω(t), where E(t) is the energy of a system, and ω(t) the oscillator frequency. Then the amplitude of oscillation is proportional to K(t)^{-1/4}, and can be made small if the laser intensity rise-time is slow enough. Therefore, the experimental requirements for a gas-filled damping cell above atmospheric pressure to achieve proper alignment could be eliminated, or at least relieved, if the initial rotation of the molecule occurs sufficiently fast to ensure adiabatic conditions in which the molecule remains instantaneously in equilibrium with the applied, slowly varying field. The requirement for this is that the switch-on time of the field greatly exceeds the natural oscillation period of the molecule T₀.^{9, 19, 20} That this is certainly possible is indicated in Table 1, where the transit time is 200 ns for a 10 micron laser focus. The switch-on time of the laser may be controlled either by spatial shaping of the field using the focusing lens or by adjusting the molecule velocity. For the smallest protein and molecule velocity of 50 m/s from Table 1 we evidently require that the field rises to its maximum value over a distance greater than (0.90/200)×10=0.045 microns, which is much less than the value expected for a Gaussian beam. On the other hand, for a Gaussian beam, the time required to reach an acceptably small amplitude of oscillation may be too large as compared to sharper beams, and may not compensate for the overall better alignment in the center of a Gaussian beam. So we may then have the opposite problem—to make the edges of the laser beam sharp enough. The optimum conditions for the beam profile should be determined, such that a molecule in the laser beam achieves a reasonably good alignment in a reasonably short time, which is small compared to the exposure time.

In order to determine the conditions for adiabatic alignment, we numerically solve Eq. (5) with ζ=0 for a particle traversing a laser beam with an intensity profile described by

$$I ( r ) = \{ \begin{matrix}{I}_{0} , r \leq {r}_{0} \\ {I}_{0} \cdot {2}^{\frac{{( r ( t ) - {r}_{0} )}^{2}}{{r}_{1 / 2}^{2}}} , r > {r}_{0}\end{matrix} , \qquad ( 10 )$$

where r₀ defines the radius of the central area with uniform intensity, 2r_{1/2} is the FWHM for the Gaussian edge of the beam, and the normalization constant I₀ is defined by a laser power of 100 W. The value of r_{1/2}=0 corresponds to an abrupt non-adiabatic switch-on, and r₀=0 is the slowest intensity rise-time achieved for Gaussian profile. At r_{1/2}=0 (sharp edge) the value chosen for r₀ was 5 micron (the laser focused on the spot with a diameter of 10 micron). The Runge-Kutta method was employed for integration. It was tested by comparing the numerically calculated trajectory with the closed-form solution of the problem, obtained for a Lorentz distribution.²¹ We determined the motion of a large heavy (40.5×10⁶ Da) TMV particle for the laser profiles with (1) Gaussian shape, (3) abrupt edges, and (2) intermediate edge sharpness. For the non-adiabatic condition (3) the molecule undergoes violent oscillations with amplitude equal to the angle at which it enters the beam. But even a minor smearing of the beam edge results in a dramatic drop of the particles oscillation amplitude within the beam (curve 2). Further smearing of the beam edges slowly reduces the oscillation amplitude to its minimum value. The adiabatic conditions can also be modified by changing the molecule velocity for a given laser beam profile. Here the small protein Lysozyme passes through a Gaussian beam with different velocities, and the molecular alignment (which can be better than a few degrees) is significantly affected by the particle velocity. These data show the degree of alignment in the center of the laser focus as a function of the field intensity switch-on time r_{1/2}/v, where v is the particle velocity. The data can be fitted by a power law, with a power of −0.45. The alignment angle is about 4 times larger for TMV as compared to Lysozyme under similar conditions, and this ratio slowly increases for larger values of r_{1/2}/v. In the case of TMV, in order to confine the molecule alignment within 5°, the time of flight through the region with rising laser intensity must be 600 ns, while for Lysozyme a misalignment of 2° is achieved already at an entry time of 100 ns. The one-dimensional model described above does not take into account the angular momentum about the molecular long axis. The gyroscopic effects of this angular inertia result in an effective potential, confining the molecule motion between two polar angles θₘᵢₙ and θₘₐₓ. For thermal energies small compared to the potential of the molecule polarizability interaction with the electric field, this effective potential approaches the shape of the polarizability interaction potential, and has an additional pole at θ=0. Thus the problem can be reduced to a one-dimensional rotation about the field direction, however with θₘᵢₙ □0. Numerical integration of the equation of motion in the θ coordinate shows that the one-dimensional approximation, applied in this paper, satisfactorily describes free oscillations of TMV in a laser electric field even at room temperature, while for Lysozyme deviations from a three-dimensional behavior become small only at very low temperatures, when quantum mechanical effects become important. A complete treatment of a 3D adiabatic alignment,²² taking into account the rotational friction and thermal fluctuations, will be described in a subsequent paper.
5. Discussion and Conclusions

Since the interaction energy of the particle with the laser beam is proportional to cos²θ for this simple one-dimensional case, the restoring force is zero for θ=90°, and an inverted molecule has the same energy as an erect one. In general laser alignment is sensitive to the direction but not the sense of the three molecular axes, and laser alignment of this type (containing a mixture of molecular orientations in the beam for a molecule with no symmetry) has been achieved by several groups using elliptically polarized laser light.²² The result will be to introduce spurious mirror planes of symmetry due to two-fold rotation about these axes into the two-dimensional diffraction pattern, in addition to the inversion symmetry of all single-scattering patterns (Friedel's law). However, recent work has shown that a charge-denisty map can be reconstructed from such an orientation-averaged diffraction pattern, even when there is ambiguity in the molecule's direction.²³ Therefore, absolute alignment may not be needed. Since proteins consist of just 20 amino acids of known structure and (usually) sequence, for which the bond angles and lengths are known, the addition of this a-priori information may also help solve the phase problem from orientation averaged diffraction data.²⁴

In summary, we find that the damping time in a high pressure gas cell can be made short compared to the time taken for molecules to traverse the beam. Such a gas cell could be used for hard X-ray diffraction experiments. A suitably shaped laser field might be used for experiments in vacuum (electron diffraction) to provide adiabatic alignment, thus obviating the need for a damping gas cell.

### REFERENCES FOR EXAMPLE 2

¹J. C. H. Spence and R. B. Doak, Phys. Rev. Lett. 92, 198102-1 (2004).
²J. C. H. Spence, K. Schmidt, J. S. Wu, G. Hembree, U. Weierstall, B. Doak, and P. Fromme, Acta Cryst. A61, 237 (2005).
³A. Lindinger, J. P. Toennies, and A. F. Vilesov, J. Chem. Phys. 110, 1429 (1999).
⁴B. Friedrich and D. Herschbach, Phys. Rev. Lett. 74, 4623 (1995); H. Stapelfeldt and T. Seideman, Rev. Mod. Phys. 75, 543 (2003).
⁵L. S. Bartell and J. Huang, J. Phys. Chem. 98, 7455 (1994).
⁶J. M. Zuo, I. A. Vartanyants, M. Gao, R. Zhang, and L. A. Nagahara, Science 300, 1419 (2003) and references therein.
⁷T. Simonson, Rep. Prog. Phys. 66, 737 (2003).
⁸E. T. Arakawa, P. S. Tuminello, B. N. Khare, and M. E. Milham, Biospectroscopy 3, 73 (1997).
⁹T. Seideman, J. Chem. Phys. 115, 5965 (2001).
¹⁰G. Uhlenbeck and S. Goudsmit, Phys. Rev. 34, 145 (1929).
¹¹B. Friedrich and D. Herschbach, J. Chem. Phys. 99, 15686 (1995).
¹²P. S. Epstein, Phys. Rev. 23, 710 (1924).
¹³S. Broersma, J. Chem. Phys. 32, 1626 (1960).
¹⁴F. Perrin, J. Phys. Radium 5, 497 (1934).
¹⁵D. Brune and S. Kim, Proc. Nat. Acad. Sci. 90, 3835 (1993).
¹⁶C. T. O'Konski and B. H. Zimm, Science 111, 113 (1950).
¹⁷W. A. Shelton, K. D. Bonin, and T. G. Walker, Phys. Rev. E 71, 036204 (2005).
¹⁸L. D. Landau and E. M. Lifshitz, Mechanics, 3rd edition (Butterworth-Heinemann, Oxford, 2003).
¹⁹J. Ortigoso, M. Rodriguez, M. Gupta, and B. Friedrich, J. Chem. Phys. 110, 3870 (1999).
²⁰H. Sakai, C. P. Safvan, J. J. Larsen, K. M. Hilligsoe, K. Hald, and H. Stapelfeldt, J. Chem. Phys. 110, 10235 (1999).
²¹L. Marton, Rep. Prog. Phys. 10, 204 (1944).
²²J. J. Larsen, K. Hald, N. Bjerre, H. Stapelfeldt, and T. Seideman, Phys. Rev. Lett. 85, 2470 (2000).
23 V. Elser, http://arxiv.org/pdf/physics/0505174
²⁴S. H. W.Scheres and P. Gros, Acta Cryst. D57, 1820 (2001).

We claim:

1. A method for molecular structure determination, comprising:
(a) generating a hydrated molecule beam at a temperature of 200K or below within a vacuum chamber;
(b) passing the hydrated molecule beam through a laser beam and a diffracting beam to produce a diffraction pattern for a first alignment of a plurality of molecules in the hydrated molecule beam;
(c) passing the hydrated molecule beam through the laser beam and the diffracting beam to produce a diffraction pattern for a second alignment of a plurality of molecules in the hydrated molecule beam;
(e) repeating step (c) a desired number of times to produce diffraction patterns of further alignments of a plurality of the molecules in the hydrated molecule beam; and
(f) determining a structure of the molecule from a plurality of the diffraction patterns obtained from different alignments of the molecule.

2. The method of claim 1, wherein the hydrated molecule beam comprises hydrated molecules in vitreous ice.

3. The method of claim 2, wherein the hydrated molecule beam comprises a monodirectional stream of individual ice-jacketed molecules.

4. The method of claim 3, wherein each individual icejacketed molecule has a diameter of 1 μm or less.

5. The method of claim 1, wherein passing the hydrated molecule beam through a laser beam and a diffracting beam comprises simultaneous intersection of all three beams in an intersecting volume.

6. The method of claim 1, wherein passing the hydrated molecule beam through a laser beam and a diffracting beam comprises:
(a) passing the hydrated molecule beam through a laser beam to produce a first alignment of the molecules in the hydrated molecule beam, wherein the first alignment comprises a plurality of the molecules with a first alignment;
(b) passing the first alignment of the molecules through a diffracting beam to produce a diffraction pattern of the first alignment of the molecules;
(c) passing the hydrated molecule beam through the laser beam to produce second alignment of the the molecules in the hydrated molecular beam, wherein the second alignment comprises a plurality of the molecules with a second alignment;
(d) passing the second alignment of the molecules through the diffracting beam to produce a diffraction pattern of the second alignment of the molecule; and
(e) repeating steps (c-d) a desired number of times to produce diffraction patterns of further alignments of a plurality of the molecules in the hydrated molecule beam.

7. The method of claim 1, wherein the laser beam produces a linear polarized laser field.

8. The method of claim 1, wherein the laser beam produces an elliptical polarized laser field.

9. The method of claim 1, wherein the laser beam produces a circular polarized laser field.

10. The method of claim 1, wherein the method comprises producing at least 6 diffraction patterns of different alignments of a plurality of the molecules in the hydrated molecule beam.

11. The method of claim 1 wherein the diffracting beam comprises an electron beam.

12. The method of claim 1 wherein determining a structure of the molecule comprises combining the plurality of diffraction patterns to form a three-dimensional pattern of the molecule.

13. The method of claim 1, wherein the molecule comprises a protein.

14. The method of claim 1, wherein the molecule comprises a macromolecular assembly.

15. A device for carrying our serial diffraction, comprising:
(a) a vacuum chamber;
(b) a diffracting beam source in fluid communication with the vacuum chamber,
(c) a laser beam source in fluid communication with the vacuum chamber;
(d) a hydrated molecule beam source all in fluid communication with the vacuum chamber;
(e) a temperature control system for maintaining a temperature in the vacuum chamber of 200K or less; and
(f) a detector system in connection with the vacuum chamber;
wherein the diffracting beam source, the laser beam source, and the hydrated molecule beam source are positioned to permit beams directed from the diffracting beam source, the laser beam source, and the hydrated molecule beam source to intersect in the vacuum chamber in an intersecting volume of between 10 μl and 100 μL; and wherein the detector system is positioned so as to receive diffraction patterns from molecules in the molecule beam passing through the diffracting beam.

16. A method for transferring proteins from a liquid solution into vacuum, comprising
(a) providing a hydrated protein solution in a capillary tube at approximately room temperature;
(b) passing the hydrated protein solution through a nozzle in the capillary tube and into a gas tube volume, wherein a co- or counter-flowing gas is flowed into the gas tube volume to form a monodirectional stream of individual vitreous ice protein droplets;
(c) passing the monodirectional stream of individual vitreous ice protein droplets from the gas tube into an inlet aperture of an injection tube, wherein temperature and pressure conditions in the injection tube maintain the monodirectional stream of individual vitreous ice protein droplets; and
(d) passing the monodirectional stream of individual vitreous ice protein droplets through the injection tube into a vacuum chamber.
